(19) United States
(12) Patent Application Publication
(10) Pub. No.: US 2015/0144176 A1
(43) Pub. Date: May 28, 2015

(54) PHOTOVOLTAIC POWER BALANCING AND DIFFERENTIAL POWER PROCESSING

(71) Applicant: Massachusetts Institute of Technology, Cambridge, MA (US)

(72) Inventors: Arthur Hsu Chen Chang, Irvine, CA (US); AI-Thaddeus Avestruz, Waltham, MA (US); Steven B. Leeb, Belmont, MA (US)

(73) Assignee: Massachusetts Institute of Technology, Cambridge, MA (US)

(21) Appl. No.: 14/549,959

(22) Filed: Nov. 21, 2014

Related U.S. Application Data
(60) Provisional application No. 61/907,780, filed on Nov. 22, 2013.

(51) Int. Cl. H02S 40/36

(52) U.S. Cl. CPC H02S 40/36
USPC 136/244

(57) ABSTRACT

Power production among photovoltaic elements can be equalized through charge redistribution, which can reduce or eliminate the effect of partial shading. Also described is a technique for differential power processing by individually setting currents through different strings of photovoltaic elements.

### RELATED APPLICATIONS

This application claims priority to U.S. Provisional Application Ser. No. 61/907,780, titled “CAPACITOR-LESS PHOTOVOLTAIC (PV) CELL-LEVEL POWER BALANCING USING DIFFUSION CHARGE REDISTRIBUTION” filed on Nov. 22, 2013, which is hereby incorporated by reference herein in its entirety.

### BACKGROUND

1. Technical Field

The techniques described herein relate to balancing power among photovoltaic elements through charge redistribution. The techniques described herein also relate to differential power processing by individually setting currents through different strings of photovoltaic elements, which can reduce the power processed.

2. Discussion of the Related Art

Photovoltaic (PV) power modules include a plurality of photovoltaic cells, also referred to as “PV cells” or “solar cells.” Since each photovoltaic cell has a relatively low cell voltage, photovoltaic cells are conventionally configured as one or more strings of photovoltaic cells to produce a higher voltage. A string of photovoltaic cells has a plurality of photovoltaic cells connected in series, also referred to as a “series string” or simply a “string.” In such a configuration, the current through all the photovoltaic cells in the string (termed the “string current”) is the same. The string current is limited by the available current of the lowest-performing photovoltaic cell in the string. Conditions such as partial shading and dirt accumulation of one or more cells can severely limit the string current, which limits the available power from the string, even if only a few cells are affected out of a large string.

Connecting bypass diodes in parallel with one or more photovoltaic cells can mitigate this problem. If a cell or series combination of cells in parallel with a bypass diode does not produce a high enough voltage, the cell(s) are bypassed by the bypass diode. This approach enables the higher-performing cells to output higher currents, bypassing lower-performing PV cells or groups of PV cells altogether, potentially extracting more power from the string. However, any possible power generation from the lower performing cells is completely forgone, as they are completely bypassed by the bypass diodes. Additional losses are also incurred by directing current through the bypass diodes.

Maximum power point tracking (MPPT) algorithms are used to maximize the power produced by setting the current and voltage for individual cells or groups of cells at the point that produces the maximum power. Such algorithms can continuously adjust the current or voltage to the maximum power point, which can change with shading conditions. The inventors have appreciated that the use of bypass diodes results in an output power characteristic curve that has more than one local maximum, also termed a “non-convex” characteristic curve. The presence of local maxima complicates MPPT algorithms.

Modular architectures such as cascaded dc-dc converters with a central inverter, micro-inverters, and their sub-module variants, have been proposed to allow local MPPT through distributed control. However, such architectures process the full power from each PV cell, which is a disadvantage due to increased insertion loss. In addition, it can be impractical to scale these approaches down to the cell-level, as per-cell inductors and/or capacitor banks may be needed, which increases component count, size and/or cost.

Recently, there has been a push towards differential power processing to balance mismatches in a PV string. By only processing the power mismatch instead of the full power, significant reduction power electronics size and in power loss can be achieved, and various architectures based on this principle have been proposed. These approaches rely on the availability of external energy storage elements. For example, the sub-module integrated converter employs flyback converters, which have a discrete transformer per PV element as energy storage. In the PV-to-PV differential architecture, buck-boost converters with external inductors are used between adjacent PV elements. Discrete capacitors are needed in parallel with each PV sub-module and in between adjacent PV sub-modules in the resonant switched-capacitor converter implementation.

### SUMMARY

Some embodiments relate to a method that includes re-distributing charge among a plurality of photovoltaic elements in a string using a photovoltaic element as switched charge storage to transfer charge between respective photovoltaic elements of the plurality of photovoltaic elements.

Some embodiments relate to a circuit that includes a switch network configured to re-distribute charge among a plurality of photovoltaic elements by switching a photovoltaic element in parallel with respective photovoltaic elements of the plurality of photovoltaic elements at different times.

Some embodiments relate to a method that includes switching connections between photovoltaic cells in a plurality of phases. The plurality of phases include a first phase comprising connecting a first group of one or more photovoltaic cells in parallel with a second group of one or more photovoltaic cells. The plurality of phases also include a second phase comprising connecting the first group of one or more photovoltaic cells in parallel with a third group of one or more photovoltaic cells.

Some embodiments relate to a photovoltaic energy conversion apparatus. The photovoltaic energy conversion apparatus includes a string of photovoltaic elements comprising a first photovoltaic element and a third photovoltaic element. The photovoltaic energy conversion apparatus also includes a second photovoltaic element. The photovoltaic energy conversion apparatus further includes a switch network comprising one or more switches. The switch network is configured to switch the one or more switches in a plurality of phases. The plurality of phases includes a first phase comprising connecting the second photovoltaic element in parallel with the first photovoltaic element. The plurality of phases also includes a second phase comprising connecting the second photovoltaic element in parallel with the third photovoltaic element.

Some embodiments relate to a photovoltaic energy conversion system comprising a plurality of strings of photovoltaic elements. The photovoltaic energy conversion system includes a controller that selects, based on an output power of the photovoltaic system, a total current to be drawn from the photovoltaic system and individual string currents to be drawn from individual strings of the plurality of strings of photovoltaic elements. The photovoltaic energy conversion system also includes at least one current source controlled by the controller to draw the total current from the photovoltaic system and the individual string currents from the individual strings.

Some embodiments relate to a photovoltaic energy conversion method for a photovoltaic energy conversion system comprising a plurality of strings of photovoltaic elements. The photovoltaic energy conversion method includes selecting, based on an output power of the photovoltaic system, a total current to be drawn from the photovoltaic system and individual string currents to be drawn from individual strings of the plurality of strings of photovoltaic elements. The photovoltaic energy conversion method also includes drawing the total current from the photovoltaic system and the individual string currents from the individual strings.

Some embodiments relate to a method that includes re-distributing charge among a plurality of photovoltaic elements in a string using a capacitive element as switched charge storage to transfer charge between respective photovoltaic elements of the plurality of photovoltaic elements. The photovoltaic elements may be individual photovoltaic cells.

Some embodiments relate to a circuit that includes a switch network configured to re-distribute charge among a plurality of photovoltaic elements by switching a capacitive element in parallel with respective photovoltaic elements of the plurality of photovoltaic elements at different times. The photovoltaic elements may be individual photovoltaic cells.

The foregoing summary is provided by way of illustration and is not intended to be limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 shows a single-diode equivalent circuit model of a photovoltaic cell.

FIG. 2A shows the single-diode equivalent circuit model of a photovoltaic cell with a shunt diode capacitance, and the capacitance characterization circuit.

FIG. 2B shows the measured capacitance has a linear relationship to the photovoltaic cell diode current.

FIG. 2C shows a waveform for a photovoltaic cell capacitance measurement.

FIG. 3A shows a diagram of a charge re-distribution circuit that includes a flying capacitor, according to some embodiments.

FIG. 3B shows curves of output power versus output current for a series string that implements charge redistribution using a flying capacitor, the same series string without charge re-distribution or bypass diodes, and for a series string with bypass diodes and without charge re-distribution.

FIG. 3C shows a circuit diagram illustrating the location of bypass diodes in parallel with each cell, for the curve of FIG. 3B showing output power with bypass diodes and no charge re-distribution.

FIG. 4A shows a diagram of a charge-redistribution circuit that uses a flying photovoltaic element, according to some embodiments.

FIG. 4B shows curves of output power versus output current for the circuit of FIG. 4A, as compared to other configurations.

FIG. 5A shows a diagram of a charge re-distribution circuit that includes a ladder configuration of photovoltaic elements, according to some embodiments.

FIG. 5B shows curves of output power versus output current for the circuit of FIG. 5A, as compared to other configurations.

FIG. 6 shows a diagram of a charge re-distribution circuit that includes a ladder configuration of photovoltaic elements, generalized to a circuit with N photovoltaic elements, according to some embodiments

FIG. 7A shows a diagram of the circuit of FIG. 5A during a first switching phase, according to some embodiments.

FIG. 7B shows a diagram of the circuit of FIG. 5A during a second switching phase, according to some embodiments.

FIG. 8A shows output voltage and current versus time for a 5-cell series string under uniform irradiance by sweeping the output current at 1 ampere per second.

FIG. 8B shows the output power versus current for a 5-cell series string compared to the 3-2 ladder configuration of FIG. 5A.

FIG. 9A shows the output power versus current for the 3-2 ladder configuration of FIG. 5A compared to other configurations in the case of 2 cells being shaded by 40%.

FIG. 9B shows the output power versus current for the 3-2 ladder configuration of FIG. 5A compared to other configurations in the case of one cell being shaded by 40% and another cell being shaded by 75%.

FIG. 10 shows an architecture for differential power processing of respective strings of photovoltaic elements, according to some embodiments.

FIG. 11 shows a plot of the output power versus output current for a 9-cell series string, a 5-4 DCR string using an architecture as illustrated in FIG. 6, and a 5-4 DCR string using an architecture as illustrated in FIG. 10, with uniform irradiation.

FIG. 12 shows a plot of the output power versus output current for a 9-cell series string, a 5-4 DCR string using an architecture as illustrated in FIG. 6, and a 5-4 DCR string using an architecture as illustrated in FIG. 10, with four cells shaded by 50%.

FIG. 13A-F illustrate the simulated output power contours over the space spanned by the total output current Iₒᵤₜ and the current divide ratio D under various shading conditions.

FIG. 14 shows an example implementation of a current divider interface, according to some embodiments.

### DETAILED DESCRIPTION

Described herein is a technique and apparatus that can balance power among photovoltaic cells to increase energy extraction. Such a technique can improve power production under partial shading conditions, and can enable extracting the maximum power from each photovoltaic cell. To balance power among photovoltaic cells, one or more capacitive elements are connected and disconnected to respective photovoltaic cells (or groups of cells) at a suitable switching frequency to re-distribute charge among them, such that they are maintained at substantially the same voltage. By re-distributing charge among photovoltaic cells in a string, the effects of partial shading on peak power tracking efficiency can be eliminated. Such a charge re-distribution technique allows for high efficiency, as it processes the power mismatch between respective photovoltaic cells or groups of photovoltaic cells instead of processing the full power produced. A string of photovoltaic cells balanced by such a technique exhibits a power versus current characteristic that is convex, and does not have local minima or maxima, which can greatly reduce the cost and complexity of the maximum power point tracking (MPPT) algorithm.

The inventors have recognized and appreciated that the intrinsic capacitance of a photovoltaic cell (e.g., the diffusion capacitance) may be used as an energy storage element for transferring charge among respective photovoltaic cells or groups of cells. The intrinsic capacitance of a photovoltaic cell may be used as a switched capacitance that is connected and disconnected from respective photovoltaic cells or groups of cells in succession, thereby re-distributing and balancing charge among them. Since the diffusion charge is shown to dominate at the maximum power point, such a technique is termed diffusion charge redistribution (DCR). An advantage of implementing charge re-distribution using the intrinsic capacitance of a photovoltaic cell is that no external passive components are needed for charge re-distribution, which can reduce power electronics cost, size and/or complexity. Power balancing can be performed by switching one or more photovoltaic cells or combinations of photovoltaic cells (e.g. series/parallel combinations) in parallel with respective cells or groups of photovoltaic cells. Accordingly, the effects of partial shading can be reduced or eliminated without needing to introduce any passive energy storage components (e.g., capacitors, inductors, or transformers) into the system.

Significant advantages in manufacturing of photovoltaics can be obtained by power balancing between photovoltaic cells. Since power balancing can compensate for mismatches between photovoltaic cells, the complexity of testing and binning during cell manufacturing can be reduced or even eliminated entirely. For example, testing on a cell-by-cell basis may be eliminated. Accordingly, the complexity and cost of manufacturing photovoltaics can be reduced significantly. Prior to describing embodiments of techniques and circuits for charge re-distribution, analysis and characterization of a photovoltaic cell capacitance will be described.

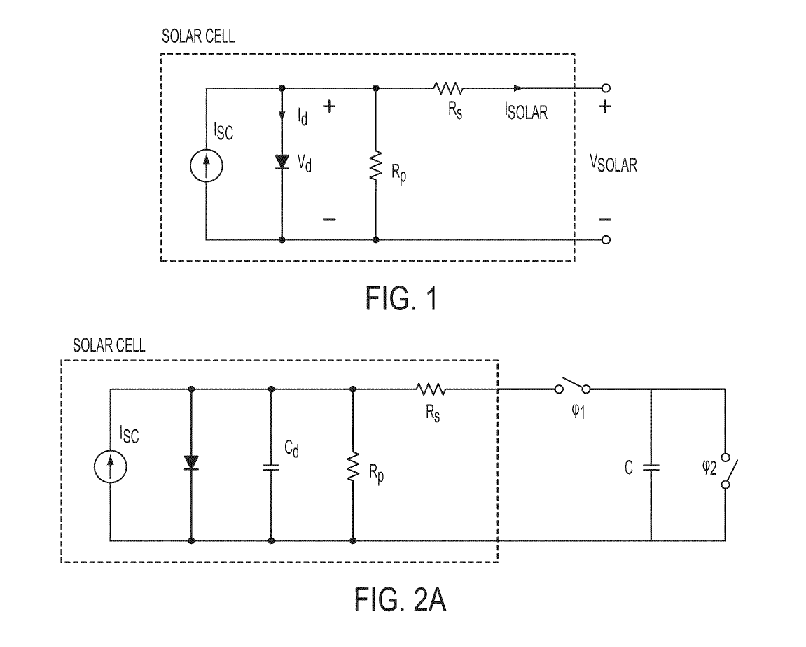

The commonly used single-diode equivalent circuit model of photovoltaic cells proposed in previous studies is shown in FIG. 1. The I-V characteristic of the equivalent photovoltaic cell model can be expressed as

$${I}_{solar} = {I}_{SC} - {I}_{d} - \frac{{V}_{d}}{{R}_{p}} . \qquad ( 1 )$$

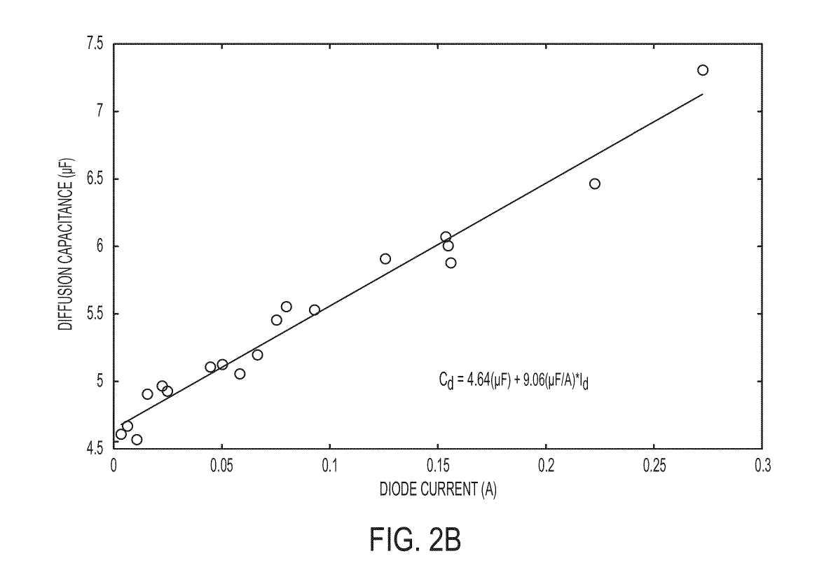

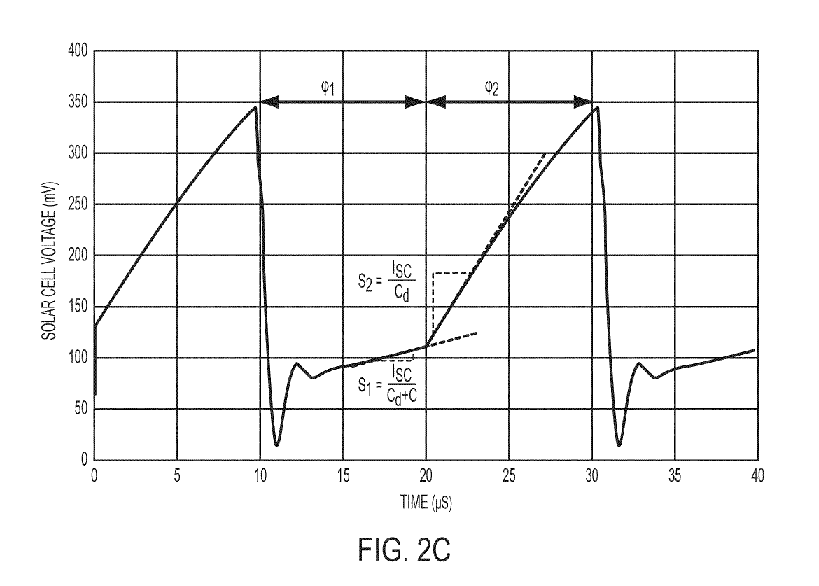

However, the model in FIG. 1 does not completely capture the dynamics of a photovoltaic cell. There is a significant amount of diode capacitance associated with the cell, which conventionally has been ignored as a parasitic element for the purposes of MPPT. The equivalent circuit model with a shunt diode capacitance is illustrated in FIG. 2A.

The capacitance of a photovoltaic cell (also referred to herein as the “intrinsic capacitance” of the photovoltaic cell) is equal to the sum of the diffusion capacitance and the depletion layer capacitance. Since the intended operating photovoltaic cell voltage is near the maximum power voltage (Vₘₚ), the diffusion capacitance effect dominates at the maximum power voltage and the depletion layer capacitance can be neglected. Diffusion capacitance is the capacitance due to the gradient in charge density inside a photovoltaic cell. The diffusion capacitance has an exponential dependency on the photovoltaic cell voltage, or a linear dependency on the photovoltaic cell diode current. Specifically, the diffusion capacitance C_{d} can be expressed as

$${C}_{d} = \frac{{τ}_{F}}{{V}_{T}} \cdot {I}_{0} \cdot exp ( \frac{{V}_{d}}{η \cdot {V}_{T}} ) = \frac{{τ}_{F}}{{V}_{T}} \cdot ( {I}_{0} + {I}_{d} ) = {C}_{0} + \frac{{τ}_{F}}{{V}_{T}} \cdot {I}_{d} . \qquad ( 2 )$$

In Equation (2), V_{d} is the photovoltaic cell diode voltage, I_{d} is the photovoltaic cell diode current, V_{T} is the thermal voltage, and η is the diode factor. Moreover, I₀ is the dark saturation current of the cell due to diffusion of the minority carriers in the junction, and C₀ is the dark diffusion capacitance. The time constant can be defined as

τ_{F}⁻¹=τ⁻¹+τ_{B}⁻¹, (3)

where τ is the minority carrier lifetime and τ_{E} is the transit time of the carrier across the diode. If the photovoltaic cell base thickness is greater than the minority carrier diffusion length, τ_{F} can simply be approximated as τ. In general, photovoltaic cells made from materials with longer minority carrier lifetimes are more efficient because the light-generated minority carriers persist for a longer time before recombining.

Previous work has revealed that photovoltaic cells (e.g., solar cells) can exhibit diffusion capacitance in the range of microfarads to hundreds of microfarads near the maximum power point voltage. Comparing, for example, to the energy storage capacitance of seven 1 μF capacitors used in the resonant switched-capacitor converter in Stauth, J. T.; Seeman, M. D.; Kesarwani, K., “A Resonant Switched-Capacitor IC and Embedded System for Sub-Module Photovoltaic Power Management,” Solid-State Circuits, IEEE Journal of, vol. 47, no. 12, pp. 3043,3054, December 2012, the photovoltaic cell itself possesses a sufficient amount of capacitance and offers a great opportunity to reduce the number of external passive components or eliminate them entirely. External energy storage capacitors are needed in the case of the resonant switched-capacitor converter in the Stauth et al. paper because power balancing is applied at the sub-module string level, and the effective capacitance of a sub-module string may not be adequate, as it is a series combination of a large number of diffusion capacitors.

Published measurements of photovoltaic cell diffusion capacitance are typically performed by applying a bias voltage across the photovoltaic cells, which may not accurately represent the effect of diffusion capacitance in the context of a switched-capacitor converter. The switching circuit shown in FIG. 2A was used to characterize a commercially available mono-crystalline photovoltaic cell (P-Maxx-2500 mA), as an example. The characterized cell measures 15.6 cm-by-6 cm, and has an open-circuit voltage of 0.55V and a short-circuit current of 2.5 A under maximum lighting conditions. The photovoltaic cell capacitance is measured ratiometrically by comparing the charging slopes during the two different phases of operation. The measurement was performed with a switching frequency of 50 kHz and repeated over a set of known external capacitances between 10 μF to 30 μF. The measured capacitance showing a linear relationship to the photovoltaic cell diode current is shown in FIG. 2B. The corresponding waveform and the slopes are illustrated in FIG. 2C.

The characterized photovoltaic cell has a worst-case, i.e., dark, capacitance of 4.64 μF. This minimum capacitance is sufficient for DCR power balancing. Note that the photovoltaic cell diode current is roughly equal to the difference between the short-circuit current and the extracted current. With the typical maximum power current (Iₘₚ) being approximately 80-95% of the short-circuit current, the diode current is 5-20% of the short-circuit current at the maximum power point, assuming negligible current through the shunt resistance. Hence, the effective diffusion capacitance for this example cell during normal operation can be as high as 6 to 9 μF.

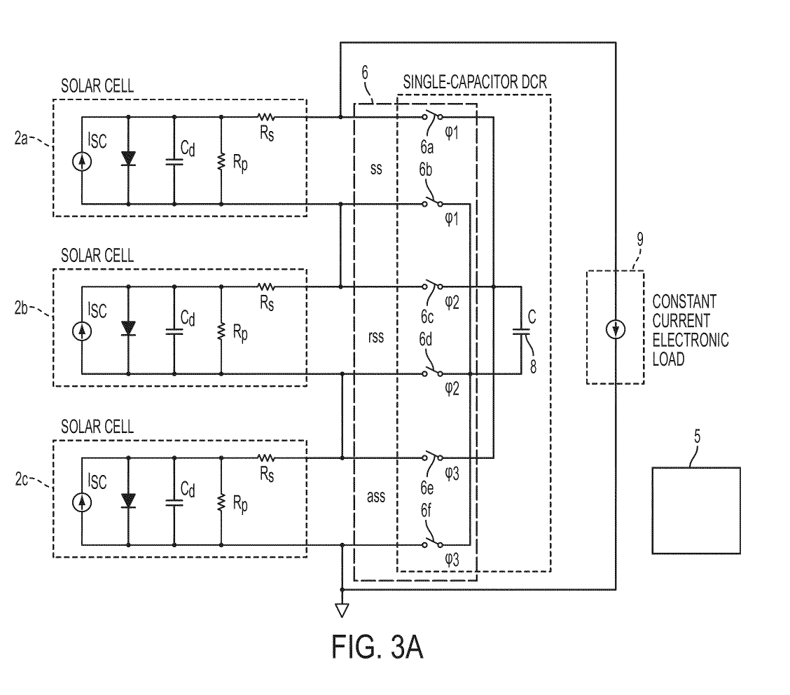

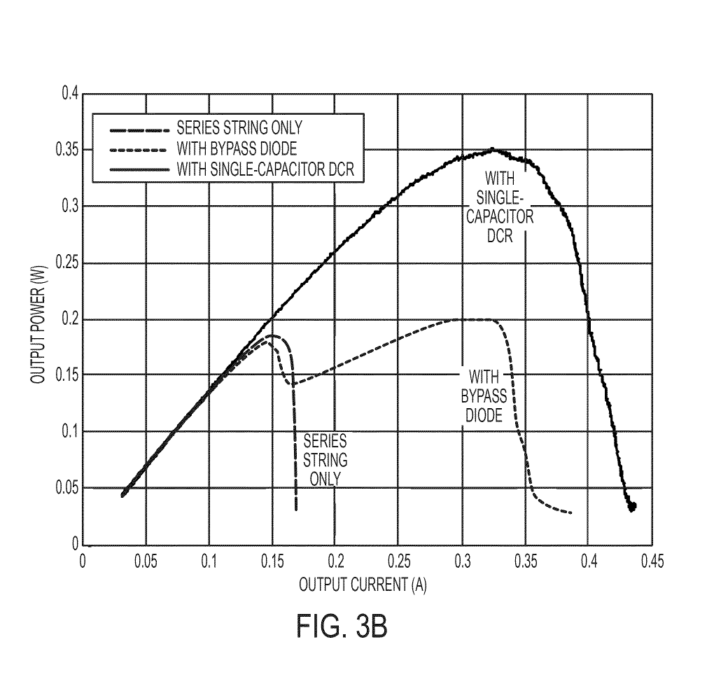

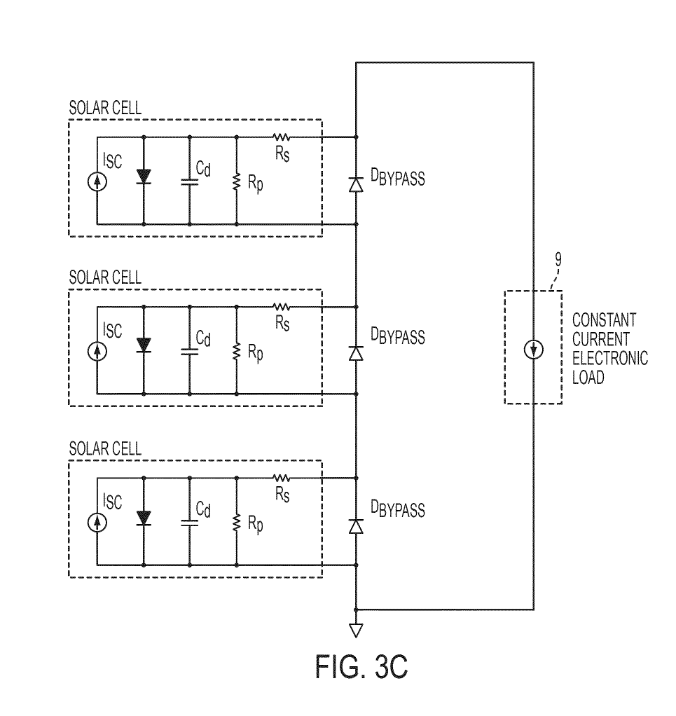

According to some embodiments, charge redistribution among photovoltaic cells or groups of cells may be performed using a flying capacitor. A diagram of a charge re-distribution circuit that includes a flying capacitor 8 is shown in FIG. 3A. The circuit of FIG. 3A includes photovoltaic cells 2a-2c, a switch network 6 including switches 6a-6f, and a flying capacitor 8. Flying capacitor 8 is sequentially connected in parallel with each of cells 2a-2c at a suitable switching frequency, which transfers charge among the cells 2a-2c and balances their output voltages. Since the cells 2a-2c are connected in a series string they all have the same current (i.e., the string current), and thus balancing their respective voltages also balances their respective power production. A current source 9 may set the string current for the cells 2a-2c in any suitable way, such as using a MPPT algorithm implemented in controller 5, for example. In some embodiments, current source 9 may be realized as an inverter that converts DC power from the photovoltaic cells 2a-2c into AC power. However, the techniques described herein are not limited in this respect, as other circuitry may be used for current source 9. FIG. 3A also shows a controller 5 coupled to the switch network 6 to control the switching of the individual switches in the switch network 6 (such connections are not shown in FIG. 3A for clarity). Controller 5 may be realized by hardware (e.g., a control circuit) or a combination of hardware and software (e.g., a microprocessor running suitable software).

The charge redistribution circuit of FIG. 3A may be operated in a plurality of phases in which the flying capacitor 8 is connected to each of the photovoltaic cells. In this example, the circuit includes three photovoltaic cells 2a-2c, and can be operated in three phases. During phase 1 (φ₁) switches 6a and 6b are turned on, and the remaining switches are turned off, thereby connecting the flying capacitor 8 in parallel with cell 2a. Subsequently, during phase 2 (φ₂) switches 6c and 6d are turned on, and the remaining switches are turned off, thereby connecting the flying capacitor 8 in parallel with cell 2b. Then, during phase 3 (φ₃) switches 6e and 6f are turned on, and the remaining switches are turned off, thereby connecting the flying capacitor 8 in parallel with cell 2c. Since there is no capacitor in parallel with the photovoltaic cells to serve as intermediate energy storage when the flying capacitor 8 is disconnected from a cell, the cells use their own diffusion capacitance to buffer the difference between their respective generated power and extracted power. The phases may then be repeated at the switching frequency of the circuit to re-distribute charge among the cells 2a-2c. However, the techniques described herein are not limited to switching the flying capacitor 8 in the order described above, as the flying capacitor 8 may be connected to the cells 2a-2c in any suitable order.

As mentioned above, the switch network 6 switches the flying capacitor into different configurations, with the phases repeating at a rate termed the switching frequency. The switching frequency may be in the range of kHz to MHz, in some embodiments. The range of suitable switching frequencies can vary depending upon the capacitances of the cells 2a-2c and the capacitance of the flying capacitor 8, among other considerations.

By using an external energy storage element (e.g., flying capacitor 8) to balance power among photovoltaic cells, differential power processing is preserved and insertion loss is insignificant. That is, if the cells are well-matched and experience the same irradiance, the cell voltages at maximum power should be the same, resulting in nearly zero net current flow into the flying capacitor 8, and therefore zero power loss.

To demonstrate the capability of the photovoltaic cell diffusion capacitance as an energy handling component in a power converter, a prototype was constructed with a single 10 μF capacitor as flying capacitor 8. The prototype included three mono-crystalline photovoltaic cells 2 and six switches 6 implemented as IRF9910 MOSFET switches, in this example.

To evaluate the efficacy of the diffusion capacitances in the context of power balancing, a partial shading condition was imposed by covering half of the top cell 2a. In the experiment, the flying capacitor 8 was switched at approximately 300 kHz with a 33% duty cycle for each phase. The output current was swept linearly on an HP 6063B DC Electronic Load at 1 A/s and the output voltage and current were measured and recorded. The output power versus output current curve for a series string with single-capacitor diffusion charge redistribution is shown in FIG. 3B. Also shown in FIG. 3B are curves of output power versus output current for the same series string with bypass diodes (and no charge redistribution), and for a series string without charge re-distribution or bypass diodes. For the curve in FIG. 3B showing the output current with bypass diodes, a circuit diagram showing the location of bypass diodes in parallel with each cell is shown in FIG. 3C.

Under a partial shading condition, the series string current is limited by the weakest link, and therefore the extracted power is reduced dramatically. With bypass diodes in place as shown in FIG. 3C, the system can extract additional power from the unshaded cells while bypassing the shaded one; the resulting non-convex output power to current characteristic curve (with two local maxima in this case) is illustrated in FIG. 3B. Charge re-distribution among the diffusion capacitances is shown to be very effective at power balancing, extracting significantly more power compared to the series string and the bypassed cases. In addition, a convex output power to current profile is retained, allowing easy integration with existing MPPT-equipped string inverters.

Although FIG. 3A illustrates a flying capacitor 8 being connected in parallel with a single photovoltaic cell at a time, the techniques described herein are not limited in this respect. In some embodiments the flying capacitor 8 may be connected in parallel with a series combination of two or more photovoltaic cells. In other words, each cell 2 in FIG. 3A may be replaced with a series combination of two or more photovoltaic cells, and the flying capacitor 8 may be switched in the same way between the respective combinations of cells. However, since a series combination of photovoltaic cells reduces their effective capacitance, the number of series-connected photovoltaic cells that are connected in parallel with the flying capacitor should be low such that a sufficiently high diffusion capacitance is available for DCR.

As discussed above, a photovoltaic cell may exhibit substantial diffusion capacitance. In some embodiments, the flying capacitor 8 of FIG. 3A may be replaced with one or more photovoltaic cells. This enables maximum power point tracking without needing any external passive components (such as flying capacitor 8) for energy storage to perform charge re-distribution.

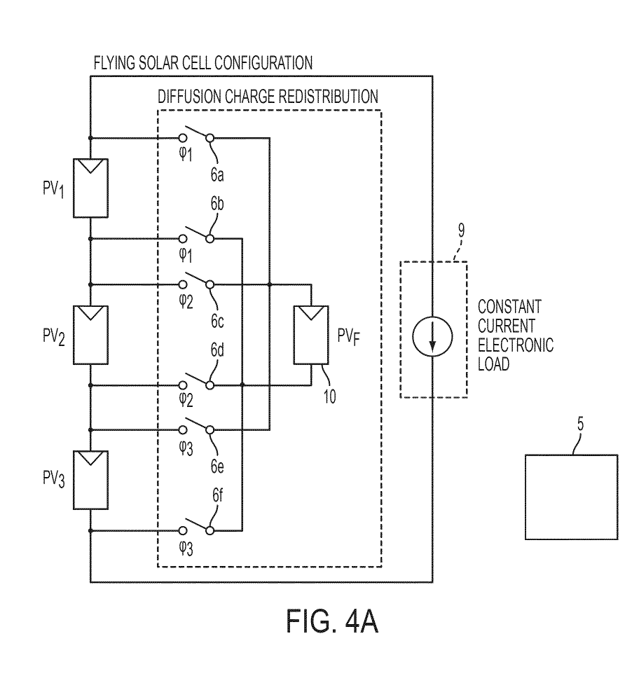

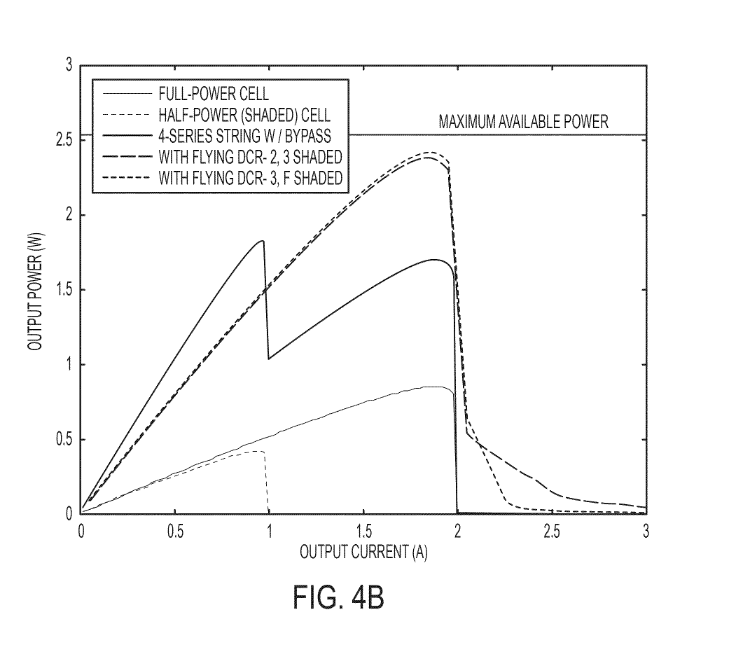

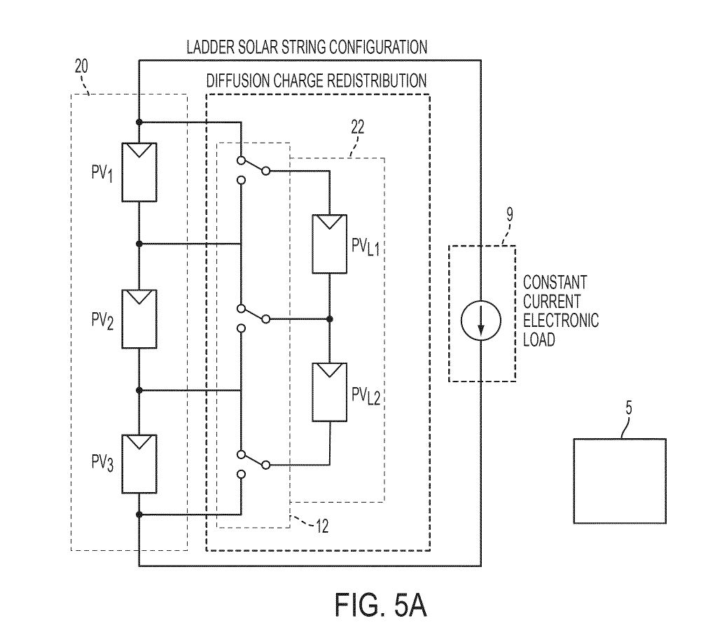

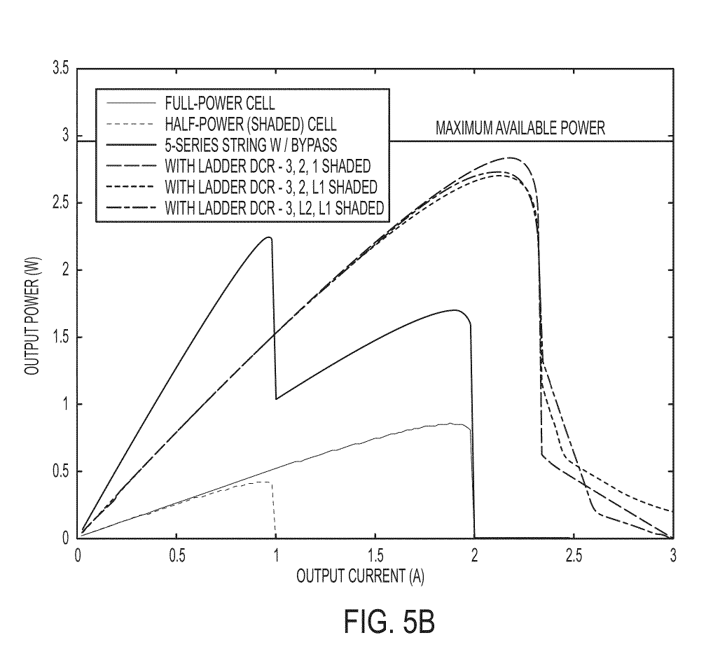

Two exemplary architectures for using a photovoltaic cell to transfer charge between photovoltaic cells are illustrated in FIG. 4A and FIG. 5A. FIG. 4A shows a charge re-distribution circuit having at least one flying photovoltaic cell 10, according to some embodiments. The circuit of FIG. 4A is similar to the circuit of FIG. 3A, with the flying capacitor 8 replaced by a photovoltaic element PV_{F}. Photovoltaic element PV_{F} may be a single photovoltaic cell or a group of two or more photovoltaic cells connected in series. Similarly, photovoltaic elements PV₁, PV₂ and PV₃ each can include a single photovoltaic cell or a group of two or more photovoltaic cells connected in series. As shown in FIG. 4A, photovoltaic elements PV₁, PV₂ and PV₃ may be connected in series and form a series string of photovoltaic elements. The circuit of FIG. 4A may be switched in the same way as the circuit shown in FIG. 3A. FIG. 4A also shows a controller 5 coupled to the switch network 6 to control the switching of the individual switches in the switch network 6.

FIG. 5A shows a charge re-distribution circuit having a ladder configuration of photovoltaic elements, according to some embodiments. A switch network 12 includes a plurality of switches that enable connecting photovoltaic elements in parallel with different photovoltaic elements at different times, thereby performing charge re-distribution. The circuit of FIG. 5A includes five photovoltaic elements, including a first string 20 (the “load-connected string”) of photovoltaic elements PV₁, PV₂ and PV₃ connected in series, and a second string 22 (the “ladder-connected string”) of photovoltaic elements PV_{L1} and PV_{L2} connected in series. FIG. 5A also shows a controller 5 coupled to the switch network 12 to control the switching of the individual switches in the switch network 12.

During a first phase, the switches of the switch network 12 connect photovoltaic element PV_{L1} in parallel with photovoltaic element PV₁ and connect photovoltaic element PV_{L2} in parallel with photovoltaic element PV₂. Then, during a second phase, the switches of the switch network 12 connect photovoltaic element PV_{L1} in parallel with photovoltaic element PV₂ and connect photovoltaic element PV_{L2} in parallel with photovoltaic element PV₃. The first and second phases are repeated at a suitable switching frequency, thereby re-distributing charge among all the photovoltaic elements.

SPICE simulations were performed for the configurations of FIG. 4A and FIG. 5A. Partial shading conditions are simulated by decreasing the short-circuit current by 50% in the affected cells. The 3-1 flying photovoltaic cell configuration of FIG. 4A is compared to a series string of 4 photovoltaic cells with bypass diodes, and the output power versus current characteristic with different permutations of two shaded cells is shown in FIG. 4B. The 3-2 ladder photovoltaic string configuration of FIG. 5A is compared to a series string of 5 photovoltaic cells with bypass diodes, and the output power versus current characteristic with different permutations of three shaded cells is shown in FIG. 5B. It is observed that the configurations of FIG. 4A and FIG. 5A are able to deliver almost all the power available under partial shading conditions, while the power output from the series strings with bypass diodes is severely affected.

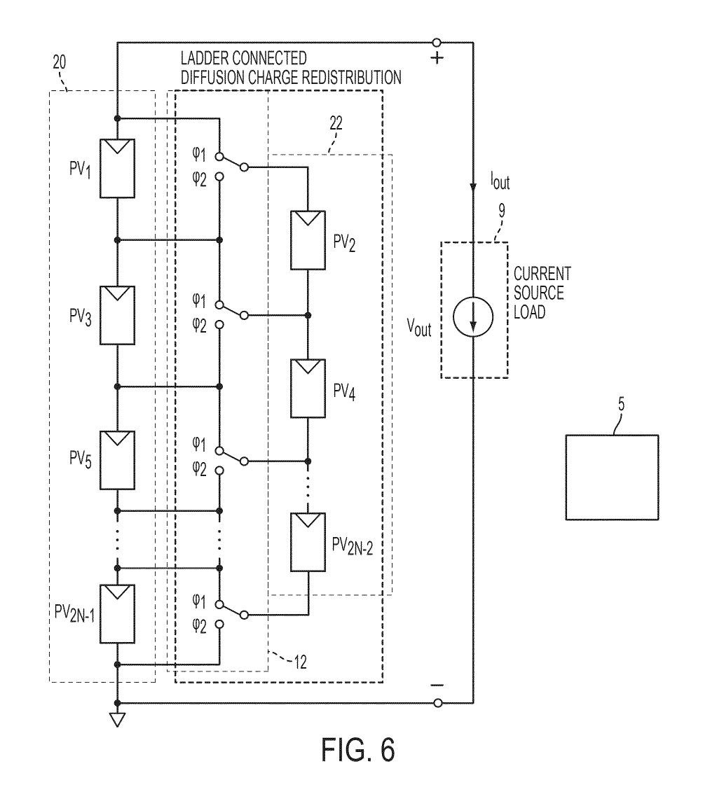

In the configuration of FIG. 4A with N cells in a series string balanced by a flying photovoltaic cell 10, the number of cells N may not be increased arbitrarily because there is only a finite amount of diffusion capacitance available in the flying photovoltaic cell 10. By contrast, the ladder configuration of FIG. 5A with N load-connected cells in a series string balanced by a ladder-connected string of N−1 cells is a fully scalable architecture. The following discussion will be focused on the ladder configuration shown in FIG. 6, which generalizes the configuration of FIG. 5A to a configuration with a larger number of cells. The load-connected cells are assigned odd designators while the ladder-connected cells are assigned even designators. This approach allows the construction of large series-strings to meet the voltage requirement of a grid-connected inverter, while making the cells appear in pseudo-parallel to mitigate power loss due to mismatch conditions. In short, the switched configuration is able to convert a series-string into an effective single “super-cell”.

One difference between the capacitor-less arrangements of FIGS. 4A, 5A and 6 with respect to the flying capacitor arrangement shown in FIG. 3A is the amount of insertion loss introduced. In the flying capacitor arrangement of FIG. 3A there is virtually no insertion loss when the photovoltaic cells are well matched. However, in the architectures of FIGS. 4A, 5A and 6, the power generated from the flying photovoltaic cell 10 or the ladder-connected string 22 is processed through switches of the switch networks 6 or 12, which leads to insertion loss. Thus, a limitation of the ladder configuration of FIG. 5A and FIG. 6 is the need to process part of the string power, specifically the power generated from the ladder-connected string 22. The power conversion efficiency of such a structure is carefully considered herein and compared to the traditional series string. The additional power conversion loss incurred from this structure compared to a series string under perfect matching conditions will be characterized as an insertion loss.

The switched-capacitor analysis can be generalized to distributed power generation for calculating the insertion loss of adopting diffusion charge redistribution. The switched-capacitor conversion loss can be characterized by two asymptotic limits: the slow- and fast-switching limits. In the slow-switching limit (SSL), the output impedance of the switching converter is calculated assuming all switches and interconnects are ideal, and the capacitors experience impulses of current. In the fast-switching limit (FSL), the capacitor voltages are assumed to be constant, and the switch and interconnect resistances dominate the losses. After deriving both the SSL and FSL losses, the total switched-capacitor loss can be computed as a combination of the slow-switching and fast-switching limit losses.

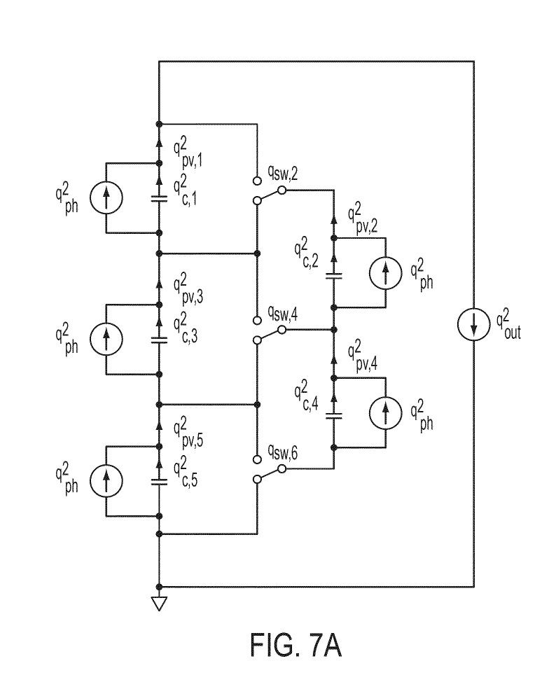

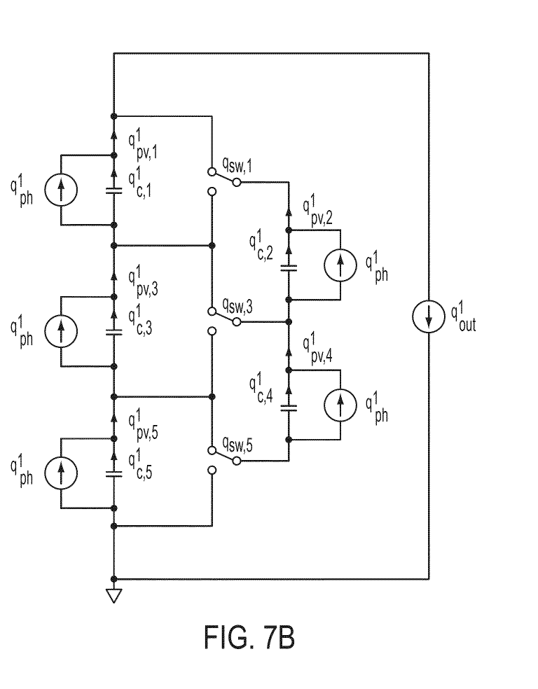

For illustration, the SSL insertion loss calculation is performed on a 3-2 example string, where N is equal to 3 following the convention shown in FIG. 6. The charge flow diagram of the 3-2 example string in the two phases are illustrated in FIGS. 7A and 7B. The charge flow is designated as q_{x,i}^{φ} where x describes the element, i represents the index number, and φ denotes the phase. For example, q_{ph,2}¹ corresponds to the total charge extracted from the second photovoltaic element during phase 1. For the insertion loss calculation, it is assumed that the photovoltaic cells are perfectly matched and each cell contains a constant photo-current source generating a total charge of qₚₕ during a complete switching cycle. For a photo-current source in this two-phase converter,

qₚₕ¹=qₚₕ²=qₚₕ/2. (4)

The output is represented by a constant current load drawing a total charge of qₒᵤₜ during a complete switching period. That is, qₒᵤₜ is the sum of the output charges delivered during phase 1 and phase 2, and therefore

qₒᵤₜ¹=qₒᵤₜ²=qₒᵤₜ/2. (5)

By using capacitor charge balance in steady state, we can write

q_{pv,i}¹+q_{pv,i}²=qₚₕ, (6)

for i=[1, 2, . . . , 5]. By Kirchhoff's current law (KCL), we can further write (7) and (8) for the two phases.

q_{pv,1}¹+q_{pv,2}¹=q_{pv,3}¹+q_{pv,4}¹=q_{pv,5}¹=qₒᵤₜ/2 (7)

q_{pv,1}²=q_{pv,2}²+q_{pv,3}²=q_{pv,4}²+q_{pv,5}²=qₒᵤₜ/2 (8)

Solving this system of equations (6), (7) and (8) iteratively yields the relationship between the photo-current from each cell and the string output current, as shown in (9).

$${q}_{out} = \frac{5}{3} \cdot {q}_{ph} \qquad ( 9 )$$

Each charge flow can then be expressed in terms of the output charge over a complete switching period. The normalized charge flow, or the charge multiplier will be defined as:

$${a}_{x , i}^{ϕ} = \frac{{q}_{x , i}^{ϕ}}{{q}_{out}} . \qquad ( 10 )$$

The SSL charge multiplier for each photovoltaic cell during the two phases for the 3-2 DCR string is summarized in Table I.

TABLE I
SSL PV CELL CHARGE MULTIPLIER FOR 3-2 DCR STRING

| Phase | SSL PV Cell Charge Multiplier | | | | |
|---|---|---|---|---|---|
| (φ) | a_{pv,1}^{φ} | a_{pv,2}^{φ} | a_{pv,3}^{φ} | a_{pv,4}^{φ} | a_{pv,5}^{φ} |
| 1 | 1/10 | 4/10 | 3/10 | 2/10 | 5/10 |
| 2 | 5/10 | 2/10 | 3/10 | 4/10 | 1/10 |

The net charge flowing into any diffusion capacitance over a complete switching cycle in steady state will be zero. Each capacitor in FIG. 7A and FIG. 7B will experience an equal but opposite charge delivery during the two phases. The magnitude of the charge flow for the capacitors can therefore be expressed as the difference between the charge extracted from the photovoltaic cell, and the charge generated by the photo-current source within the cell during either phase.

$${a}_{c , i} = \frac{\vert {q}_{c , i} \vert}{{q}_{out}} = \frac{\vert {q}_{pv , i}^{ϕ} - {q}_{ph} / 2 \vert}{{q}_{out}} \qquad ( 11 )$$

Equation (11) can be used to determine the SSL charge multipliers of the capacitors, which are summarized in Table II.

TABLE II
SSL CAPACITOR CHARGE MULTIPLIER FOR 3-2 DCR STRING
SSL Capacitor Charge Multiplier

| a_{c,1} | a_{c,2} | a_{c,3} | a_{c,4} | a_{c,5} |
|---|---|---|---|---|
| 2/10 | 1/10 | 0 | 1/10 | 2/10 |

The capacitor charge multiplier vector can be generalized to a DCR string with 2N−1 cells, where there are N cells in the load-connected string and N−1 cells in the ladder-connected string. In the general case, the output current to photocurrent ratio and the capacitor charge multiplier expressions are shown in (12) and (13) respectively.

$$\begin{matrix}{q}_{out} = \frac{2 N - 1}{N} \cdot {q}_{ph} & ( 12 ) \\ {a}_{c , i} = \frac{\vert {q}_{c , i} \vert}{{q}_{out}} = \frac{\vert N - i \vert}{4 N - 2} & ( 13 )\end{matrix}$$

The SSL output impedance of the DCR string can then be written as

$${R}_{SSL} = {\sum }_{i = 1}^{2 N - 1} \frac{{( {a}_{c , i} )}^{2}}{{C}_{d} \cdot {f}_{sw}} = \frac{1}{12} \cdot \frac{N \cdot ( N - 1 )}{2 N - 1} \cdot \frac{1}{{C}_{d} \cdot {f}_{sw}} . \qquad ( 14 )$$

In order to calculate percentage insertion loss, the ratio of the SSL output impedance to the load resistance is calculated. This can be found as an expression in terms of the performance of each cell in steady state, operating at its maximum power point with voltage Vₘₚ and current Iₘₚ. Using (12), which effectively relates cell current to output current, and the fact that the DCR string voltage equals N times the cell voltage as shown in FIG. 6, the load resistance is

$${R}_{L} = \frac{{V}_{out}}{{I}_{out}} = \frac{N \cdot {V}_{mp}}{\frac{2 N - 1}{N} \cdot {I}_{mp}} = \frac{{N}^{2}}{2 N - 1} \cdot \frac{{V}_{mp}}{{I}_{mp}} . \qquad ( 15 )$$

The insertion loss fraction, IL_{SSL} can be calculated as the ratio of the SSL output impedance of the DCR string to the load resistance,

$${IL}_{SSL} = \frac{{R}_{SSL}}{{R}_{L}} = \frac{1}{12} \cdot \frac{N - 1}{N} \cdot \frac{1}{{f}_{sw}} \cdot \frac{1}{{V}_{mp}} \cdot \frac{{I}_{mp}}{{C}_{d}} , \qquad ( 16 )$$

and the SSL efficiency of the array can be defined as one minus the SSL insertion loss. Equation (16) represents a fundamental result that is dependent on technology and material choices. It states that the SSL efficiency of a photovoltaic array configured as a DCR string is effectively dictated by the ratio of the maximum power current to the diffusion capacitance, for large N. For illustration, assume the following rounded numbers for our photovoltaic cells under maximum illumination: a maximum power voltage of 0.5V, a maximum power current of 2 A, and a diffusion capacitance of 9 μF. For a DCR string with N of 20 and a switching frequency of 1 MHz, the insertion loss can be calculated to be a manageable 3.5%.

The SSL insertion loss is not the only loss mechanism. It is possible for the DCR string to operate near the SSL-FSL transition where the loss contributions are approximately equal, or deep in FSL where the FSL losses dominate. The string output characteristics in the fast-switching limit are discussed below.

In the fast-switching limit (FSL), the capacitor voltages are assumed to be constant during a switching period. In addition, the duty cycle becomes an important consideration. For the following analysis, a 50% duty cycle is assumed for simplicity. The output impedance will again be derived in the context of the 3-2 DCR example string for illustration, then generalized to a DCR string of arbitrary size.

From FIGS. 7A and 7B, the charge flowing through the switches can be written using the PV cell charge multipliers as shown in (17).

$${a}_{sw , i} = \{ \begin{matrix}\vert {a}_{pv , i + 1}^{1} - {a}_{pv , i - 1}^{1} \vert , & i odd \\ \vert {a}_{pv , i}^{2} - {a}_{pv , i - 2}^{2} \vert , & i even\end{matrix} \qquad ( 17 )$$

where boundary cases, i.e., a_{pv,0}¹ and a_{pv,2N}² are assumed to be zero. The resulting FSL charge multiplier vector for the 3-2 DCR string is summarized in Table III.

TABLE III
FSL SWITCH CHARGE MULTIPLIER FOR 3-2 DCR STRING
FSL Switch Charge Multiplier

| a_{sw,1} | a_{sw,2} | a_{sw,3} | a_{sw,4} | a_{sw,5} | a_{sw,6} |
|---|---|---|---|---|---|
| 4/10 | 2/10 | 2/10 | 2/10 | 2/10 | 4/10 |

For a DCR string with 2N−1 total cells, the FSL switch charge multiplier vector can be derived as

$${a}_{sw , i} = \{ \begin{matrix}( N - 1 ) / ( 2 N - 1 ) , & i = 1 , 2 N \\ 1 / ( 2 N - 1 ) , & otherwise\end{matrix} . \qquad ( 18 )$$

Hence, the FSL output impedance of an arbitrarily sized DCR string is

$${R}_{FSL} = 2 \cdot {\sum }_{i = 1}^{2 N - 1} {R}_{eff} \cdot {( {a}_{sw , i} )}^{2} = 4 \cdot \frac{N \cdot ( N - 1 )}{{( 2 N - 1 )}^{2}} \cdot {R}_{eff} , \qquad ( 19 )$$

where R_{eff} is the effective resistance of the switch on-resistance in series with any interconnect resistance. Relating the FSL output impedance back to the load resistance, the FSL percentage insertion loss can be calculated as

$${IL}_{FSL} = \frac{{R}_{FSL}}{{R}_{L}} = \frac{4}{2 N - 1} \cdot \frac{N - 1}{N} \cdot \frac{{I}_{mp}}{{V}_{mp}} \cdot {R}_{eff} . \qquad ( 20 )$$

The result in (20) makes intuitive sense because the loss from the fast-switching limit is expected to be inversely proportional to the number of cells behaving like current sources. The dissipated power in the switches is approximately constant for sufficiently large N, while the total generated power increases linearly with N. Note that the factor of 4 in (20) can be derived by using the fact that the power extracted from the ladder-connected string passes through two switching devices. In addition, the current through the switches resembles a square wave, which gives an additional factor of two in power.

From (20), the FSL insertion loss, or conduction loss, can almost always be made negligible for a sufficiently large string. For example, for a DCR string with N of 20, maximum power current of 2 A, maximum power voltage of 0.5V, and an effective switch on-resistance of 15 mΩ, the insertion loss is only 0.58%.

The total insertion loss can be calculated by combining the SSL and FSL losses. A conservative approximation, the root of the quadratic sum the two loss components, will be used. That is,

IL_{TOT}≅\sqrt{(IL_{SSL})²+(IL_{FSL})²}. (21)

The charge re-distribution approach also effectively corrects for process variations between cells, which normally would limit power extraction from a string of cells. Charge re-distribution, therefore, can improve power extraction from an array of mismatched cells in comparison to other approaches for processing power. Alternatively or additionally, charge redistribution can be viewed as easing the manufacturing problem of assembling a photovoltaic array by accommodating greater cell variation while maximizing power extraction.

Process variation in photovoltaic manufacturing typically refers to the I-V mismatch between the photovoltaic cells. For a series string of photovoltaic cells, I-V mismatch can negatively impact the overall tracking efficiency because the cells may not operate at their individual maximum power points. Instead, they operate at a collective maximum power current for all the cells present in the series string.

In order to improve the cell-level tracking efficiency by reducing cell-to-cell variation, photovoltaic panel manufacturers have invested greatly in improving their manufacturing process as well as evaluating different cell binning algorithms. In the past ten years, manufacturers have been able to refine their production process and reduce the power tolerance from ±10% down to ±3%. Nevertheless, the I-V mismatch can still have higher tolerance when cells are sorted by maximum power.

The subsequent analysis follows in using a first-order approximation for cell output power under deviation from the maximum power point operation. Assuming approximately constant voltage near the maximum power point, the output power (P_{cell}) can be assumed to be step-wise linear when the cell output current (I_{cell}) is slightly perturbed around the maximum power current:

I_{cell}=(1−δ)·Iₘₚ (22)

P_{cell}(1−|δ|)·Pₘₚ (23)

To understand the effect of variation on a string, let δᵢ be a random variable which describes the deviation of the current at the collective maximum power of the string to the current of cell i at its maximum power operation. That is, the total power from a series string can be written as

$${P}_{string} = {\sum }_{i} ( 1 - \vert {δ}_{i} \vert ) \cdot {P}_{mp} \qquad ( 24 )$$

Then the expected power from a series string of N cells can be expressed as

E[P_{string}]=N·Pₘₚ·(1−E[|δ|]) (25)

Using (25), the power loss due to process variation can be approximated as the deviation from the maximum available string power N·Pₘₚ. This represents a conservative estimate; the actual power loss can be higher because the magnitude of dP/dI can be much higher when I>Iₘₚ. For a more detailed treatment, a Monte Carlo analysis of the expected power with cell-to-cell variation can be performed.

Assuming a uniform distribution of δᵢ with a range of ±5%, the loss in tracking efficiency in a series string due to process variation is approximately 2.5%. Since the DCR string is able to mitigate even larger partial shading mismatches, it will be practically indifferent to the asymmetry from process variation. Hence, the loss in tracking efficiency from cell-to-cell variation, illustrated by E[|S|] in (25), can be naturally recovered. A correction factor is introduced in the overall insertion loss calculation, and complete insertion loss from using a charge re-distribution can then be approximated as

IL_{DCR}≅(IL_{SSL})²+(IL_{FSL})²−E[|δ|]. (26)

A great advantage in performing cell-level MPPT with diffusion charge redistribution lies in the fact that the string output power becomes independent of cell-to-cell process variation. Therefore, it is possible to drastically reduce manufacturing cost by relaxing the extensive and stringent binning process currently employed in manufacturing. It may also greatly simplify manufacturing and assembly processes, as mentioned above.

A 5-cell series string experimental prototype and a 3-2 DCR string experimental prototype were constructed to further validate the proposed concept. The DCR prototype included five P-Maxx-2500 mA mono-crystalline photovoltaic cells, six IRF9910 MOSFET switches, and five LSM115J Schottky diodes. The characteristic output power versus output current curve is obtained by recording both the string output voltage and the output current as an HP 6063B DC Electronic Load sweeps the output current from 0-10 A at a slew rate of 1 ampere per second.

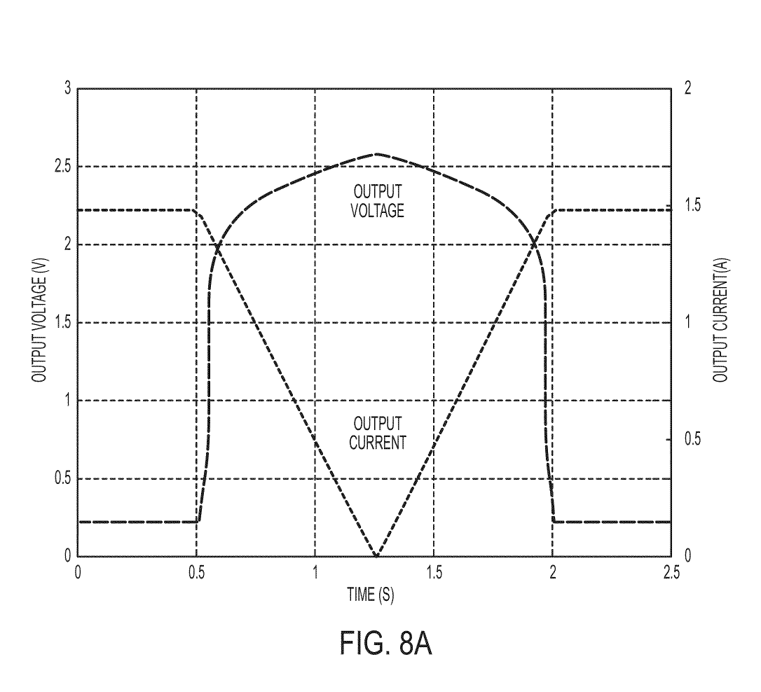

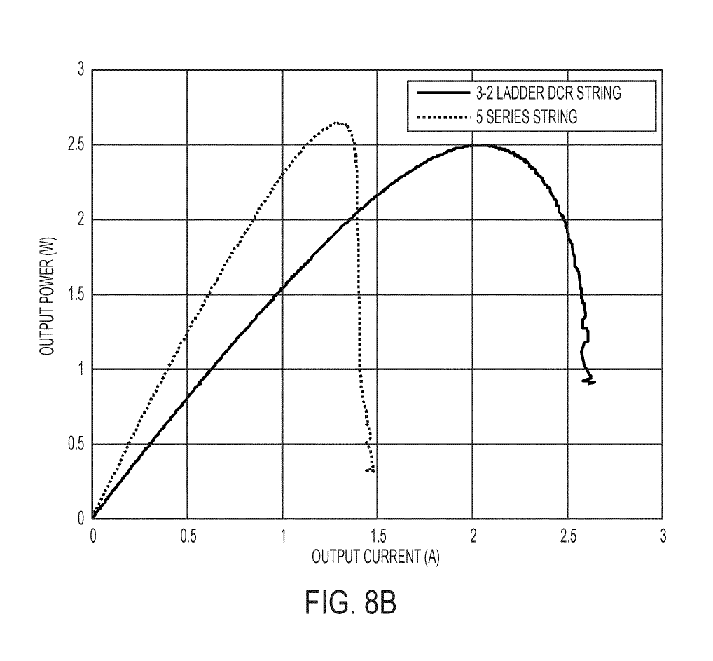

As the electronic load demands more current than the series string can supply, the current saturates at the short-circuit current of the string, as illustrated in FIG. 8A. Furthermore, the effect of process variation can be observed in the voltage waveform. That is, if the short-circuit currents of the individual cells are perfectly matched, the string is expected to have a zero output voltage at the short-circuit current. However, if there is mismatch between the cells, cells with higher short-circuit circuit can maintain a positive voltage as the string current is limited by the cells with lower short-circuit current.

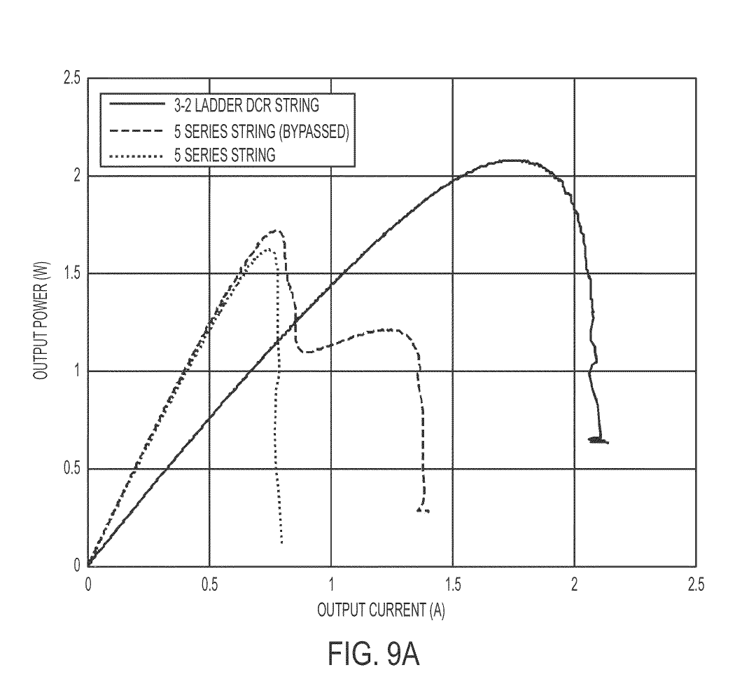

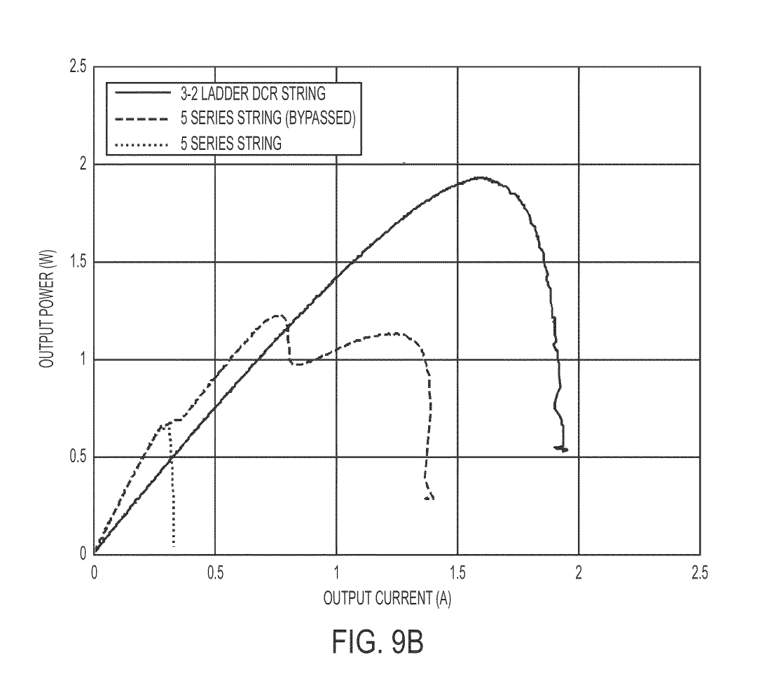

FIGS. 9A and 9B show the experimental output power measurement of a 5-cell series string with and without bypass diodes, compared to a 3-2 DCR string. From the 5-cell series string measurement under uniform irradiance in FIG. 8B, the maximum power current Iₘₚ and voltage Vₘₚ of the cells can be extracted to be 1.31 A and 0.40V respectively. The diffusion capacitance can then be calculated from FIG. 2C to be approximately 6.25 g. The DCR string has a switching frequency of 500 kHz, and the expected SSL conversion loss is 5.8% from (16). Assuming the switch on-resistance dominates the effective resistance, the expected FSL conversion loss is 4.1% from (20). Hence, the total insertion loss can then be calculated from (21) to be 7.1%.

The measured output power of the 5-cell series string has a peak at 2.63 W, and the measured output power of the 3-2 DCR string has a maximum of 2.49 W. This gives a measured efficiency of 94.7%, or a measured DCR insertion loss of 5.3%. The lower measured insertion loss, compared to the calculated 7.1%, can be attributed to the recovery of losses from process variation as shown in (26).

FIGS. 9A and 9B illustrate the measured output power characteristic curves under different shading conditions, where the shading percentage is determined by measuring the change in short-circuit current of the shaded cells. The series string is shown to lose a significant portion of the string power even when only a small percentage of the total area is shaded. With bypass diodes in place, the string is able to extract more power. However, the resulting output power characteristic curve is non-convex, and has with multiple maxima, which introduces additional constraints to the required MPPT algorithm. In the case of the DCR string, significantly more power can be extracted. Moreover, the output power characteristic curve remains convex, which greatly reduces the complexity of the required MPPT algorithm.

The maximum measured power for each configuration is tabulated in Table IV, where the extracted percentage column illustrates the ratio of power extracted to the total available power under uniform irradiance for the same configuration. It can be seen that with charge re-distribution, the extracted percentage follows one minus the overall shading percentage quite closely, which validates the effectiveness of the power balancing technique using charge re-distribution.

TABLE IV
MEASURED OUTPUT POWER COMPARISON AND EFFICIENCY SUMMARY

| | | | | | 1 Cell 40% Shaded, | |
|---|---|---|---|---|---|---|
| | | | 2 Cells 40% Shaded | | 1 Cell 75% Shaded | |
| | Uniform Irradiance | | (16% Overall Shading) | | (23% Overall Shading) | |
| Configuration | Power | Conversion | Power | Extracted | Power | Extracted |
| (N = 3) | (W) | Efficiency | (W) | Percentage | (W) | Percentage |
| Series String | 2.63 | 100% | 1.62 | 61.6% | 0.64 | 24.3% |
| Series + Bypass | 2.63 | 100% | 1.71 | 65.0% | 1.22 | 46.4% |
| DCR String | 2.49 | 94.7% | 2.075 | 83.3% | 1.92 | 77.1% |

The ladder configuration shown in FIG. 6 results in processing roughly half of the common-mode generated power, as the current from the ladder-connected PV cells flows through the switches connecting the ladder-connected PV cells to the load-connected PV cells. In the single-output topology illustrated in FIG. 6, power is extracted at the output of the load-connected string 20. Therefore, the power produced from the switched-ladder string is processed through the switching structure, regardless of the amount of mismatch present in the system. This leads to an insertion loss, which is the additional conversion loss compared to a series string under perfectly matched conditions. The insertion loss, though shown to be manageable, sets design constraints on the switch sizing and the switching frequency based on the available intrinsic photovoltaic cell capacitance, as discussed above.

Although the insertion losses have been shown to be manageable, having insertion loss on the common-mode generated power may not be attractive for panel manufacturers and system integrators when long-term project economics are considered. Therefore, in the next section, methods for enabling differential processing will be discussed and presented.

An architecture is described which enables fully differential power processing, according to some embodiments. As discussed above, differential power processing (DPP) can enable increasing the photovoltaic energy conversion efficiency. By only processing the generally small mismatch in power among PV elements, the incurred power conversion loss from performing maximum power point tracking (MPPT) can be reduced significantly. Specifically, when the PV elements are operating under matched conditions, their energy production can be extracted directly by the output load, such as a grid-tie inverter, without any intermediate processing.

As discussed above, charge re-distribution has been shown to effectively perform cell-level power balancing on the level of a photovoltaic cell or group of cells, without needing local intermediate energy storage components. Described herein is a technique for differential processing of power from a plurality of strings of series-connected power generating elements (e.g., photovoltaic elements). Such a technique can be used for differential processing of power from a plurality of strings of series-connected photovoltaic elements, with our without performing charge re-distribution.

A differential power processing architecture is described that can be applied to the string-level power electronics. In some embodiments, differential power processing is performed at the string level in a way that is independent of, and decoupled from, the MPPT algorithm and associated electronics. In some embodiments, string-level differential power processing allows direct energy extraction from both the load-connected string 20 and the ladder-connected string 22.

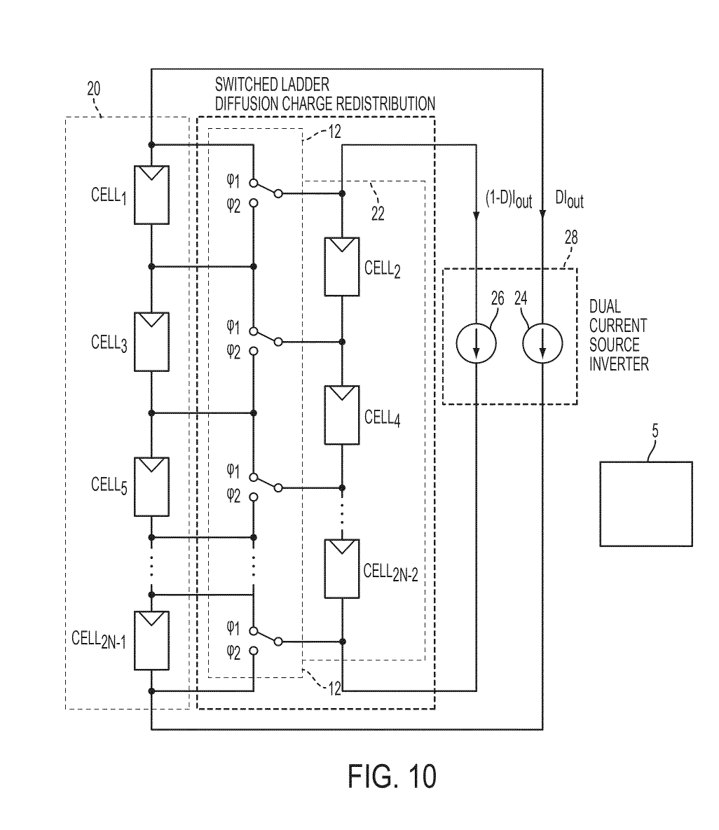

FIG. 10 shows an architecture for differential power processing of respective strings of photovoltaic elements. An optional switch network 12 is shown which enable charge re-distribution among the photovoltaic elements, according to the techniques discussed above. As shown in FIG. 10, separate current sources 24 and 26 are connected to each string, which allows independently setting the string current for each string of photovoltaic elements 20 and 22. As shown in FIG. 10, a first current source 24 is connected to the first string 20 of photovoltaic elements and a second current source 26 is connected to the second string 22 of photovoltaic elements. The current sources 24 and 26 provide circuitry for direct, independent energy extraction from both the load-connected string 20 and the ladder-connected string 22, thereby enabling differential power processing. In some embodiments, the current sources 24 and 26 may be part of the power electronics of an inverter that produces AC power (e.g., to supply the AC power to an AC power grid). In some embodiments, the current sources may be realized as a dual current source inverter input interface 28. The dual current source input interface 28 can be implemented using two isolated string inverters, or via a current divider interface preceding a central inverter, for example. However, the techniques described herein are not limited to realizing the current sources as an input interface to an inverter, as the techniques described herein are not limited to supplying AC power. The current sources 24 and 26 may be realized by any suitable electronics (e.g., power electronics) that can establish selected current levels (e.g., DC current levels) through the strings 20 and 22 independently of one another. FIG. 10 shows at least one controller 5 coupled to the switch network 12 to control the switching of the individual switches in the switch network 12 and to control the currents provided by the current sources 24 and 26. The controller 5 can select, based on an output power of the photovoltaic system, a total current to be drawn from the photovoltaic system and individual string currents to be drawn from individual strings 20 and 22.

In such a topology, cell-level power balancing and maximum power point tracking may be achieved by charge redistribution on the photovoltaic cells' diffusion capacitance. When all the cells operate under perfectly matching condition, they have the same maximum power voltage Vₘₚ and maximum power current Iₘₚ. To extract the maximum power from the strings, the current sources would need to extract Iₘₚ from each and every cell, which can be accomplished by each current source 24 and 26 demanding a current of Iₘₚ from their respective strings 20 and 22. This corresponds to an even current divide ratio of D=0.5. Under this condition, the photovoltaic cells would each exhibit the maximum power voltage Vₘₚ so that no charge transfer will occur during the switching events in the switches 12 of the ladder. Hence, there is no power processing and no insertion loss associated with adopting diffusion charge redistribution in a ladder architecture compared to that of a series string.

It can also be observed that when the maximum power current Iₘₚ is being extracted from the ladder-connected string of photovoltaic cells 22, their active elements are effectively nulled from the perspective of the load-connected string of cells 20. Therefore, the ladder-connected cells 22 appear as a passive string of capacitors to the load-connected string of cells 20. By symmetry, the same observation can be made of the load-connected cells 20 from the perspective of the ladder-connected cells 22. Under matched conditions, this means that no power from the ladder-connected string 20 is processed by the load-connected string 22, and vice versa.

To validate the differential power processing capability in the proposed topology, a SPICE simulation is performed comparing the following three configurations: a 9-series string, a 5-4 DCR string with one output, as shown in FIG. 6, and a 5-4 differential DCR string (a “dDCR string”) as shown in FIG. 10. In this simulation, the cells are assumed to be matched with uniform irradiance, and each generate a short-circuit current of ISC=2.5 A. In addition, an even current divide ratio of D=0.5 is used in the dDCR string as discussed previously.

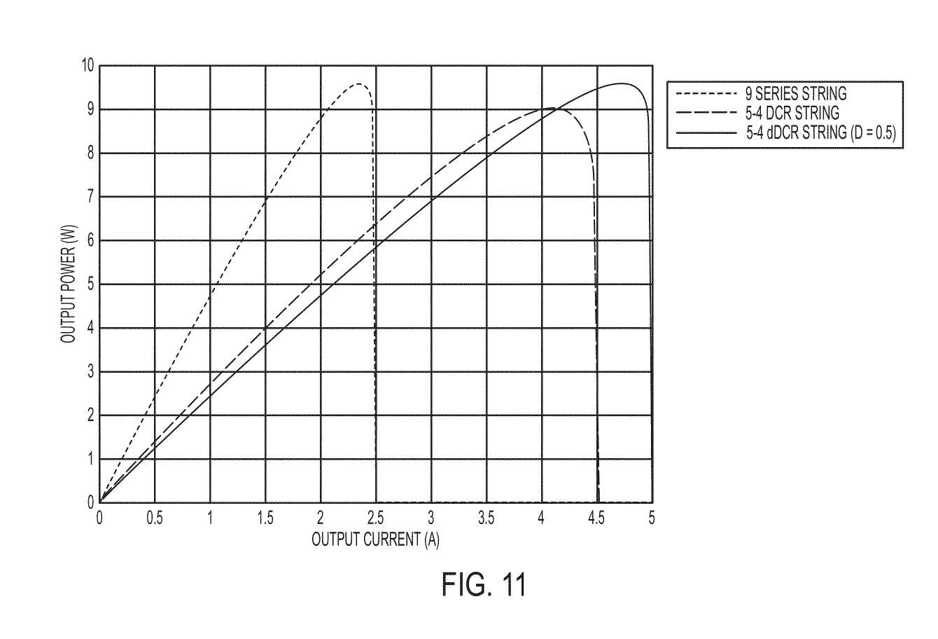

FIG. 11 shows a plot of the output power versus output current for the three different configurations. The x-axis on the plot corresponds the total current extracted, which is the sum of the load-connected and ladder-connected string currents in the case of the dDCR string. In contrast to the single-output DCR string, the dDCR string exhibits no insertion loss and extracts the same peak power as the series string. This result verifies the differential power processing capability of the proposed architecture.

For minimum insertion loss under perfectly matched conditions, the current sources 24 and 26 should demand equal currents, in particular the maximum power current Iₘₚ, from their respective strings 20 and 22. However, in some cases asymmetric shading conditions may exist between the strings 20 and 22. In some embodiments, the current divide ratio of the current sources 24 and 26 can be used as an extra degree of freedom to minimize the amount of processed power. This is illustrated in FIG. 10 by the current divide ratio D, where the current commanded by an inverter is split into D·Iₒᵤₜ through the load-connected string and (1·D)·Iₒᵤₜ through the switched-ladder string. Selecting the current divide ratio D can be used to optimize or otherwise improve power extraction for a topology having a plurality of strings with asymmetric shading conditions.

For example, in the case of a dDCR system of FIG. 10 with all of the ladder-connected cells 22 shaded by 50%, the current divide ratio D can be tuned to maximize power extraction. Because photovoltaic cells are current generation devices, in order to maximize the extracted power from each cell while minimizing the amount of processed power, the commanded current from the load-connected string 20 should be roughly twice that from the ladder-connected string 22. In other words, with a current divide ratio of D=0.67, the amount of processed power is close to zero, whereas in the case of the single-output DCR with D=1, approximately a quarter of the generated power has to be processed through the switches 12. Hence, the dDCR topology with the added tuning ability is expected to extract a higher peak power compared to the DCR configuration shown in FIG. 6.

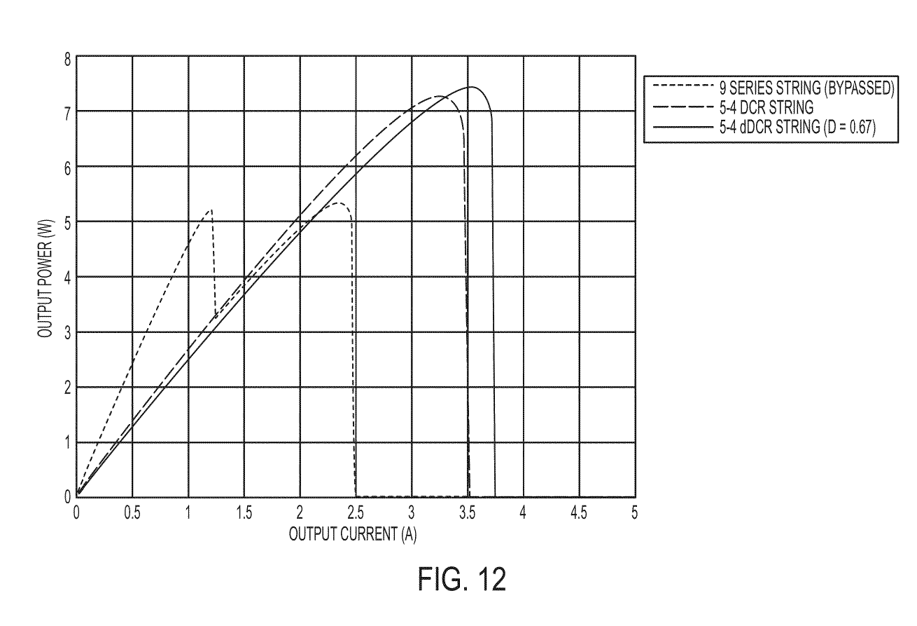

A SPICE simulation comparing a 9-series string with per-cell bypass diodes, a 5-4 DCR string, and a 5-4 dDCR string is again used to illustrate the utility of the current divide ratio tuning. In this simulation, four cells are affected by partial shading, and partial shading conditions are simulated by decreasing the short-circuit current by 50% in the affected cells. In the 5-4 DCR and dDCR architectures, the four shaded cells are chosen to be the ladder-connected cells 22 according to the discussed example FIG. 12 illustrates the extractable power under this partial shading condition. It can be observed that the DCR and dDCR configurations are able to deliver significantly more power under mismatch by performing power balancing at the cell-level. In addition, the benefit of having the current divide ratio tuning capability is demonstrated. By setting the current divide ratio to minimize the amount of processed power, more usable power can be extracted from the system.

In the general case with arbitrary shading patterns, finding the optimal current divide ratio may not be as simple as described in the previous example. An output power optimization may be performed over the space spanned by the following two variables: the total output current Iₒᵤₜ and the current divide ratio D. The convexity of such a multivariable optimization problem is discussed below.

It was demonstrated above that the output power versus output current characteristic for the original DCR configuration is a convex upwards function, i.e., there is no more than one maximum, regardless of partial shading conditions. This is perhaps one of the most appealing benefits of adopting charge re-distribution. Without the possibility of being stuck at a local maximum power point, the string-level maximum power optimization algorithm can be greatly simplified.

The intuition behind the output power convexity with respect to output current of the single-output DCR topology can be derived from the switching configuration. The ladder switching topology effectively transforms the series string connections of the photovoltaic cells into pseudo-parallel ones. A parallel combination of photovoltaic cells is essentially equivalent to constructing a single large photovoltaic cell, and the pseudo-parallel combination of photovoltaic cells then creates a single “super-cell” with rescaled voltage and current characteristics. Regardless of scaling, if a string behaves as and exhibits characteristics of a single cell, then the output power versus output current curve should be convex.

In the case of the two-variable optimization problem, the same intuitive argument does not apply directly as the optimization now is trying not only to maximize the power extraction from the photovoltaic cells, but also to minimize the amount of power processed by diffusion charge redistribution. Simulation over key corner cases of partial shading conditions as well as randomly generated shading patterns are presented.

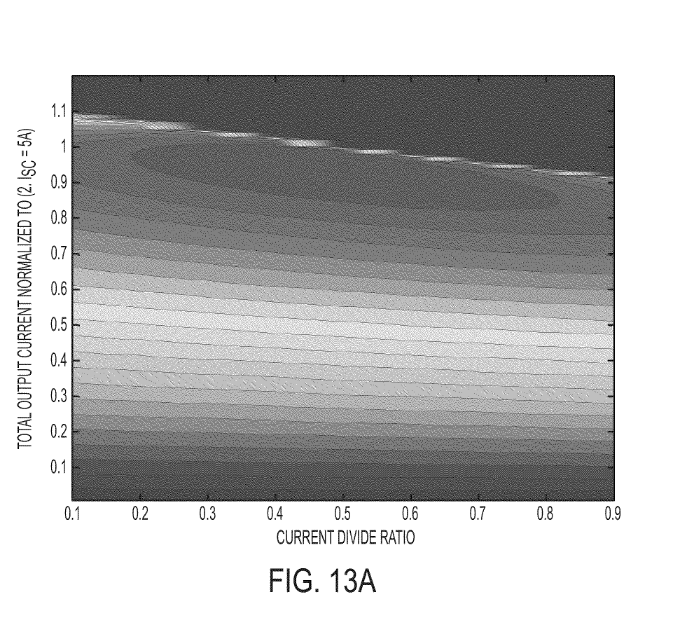

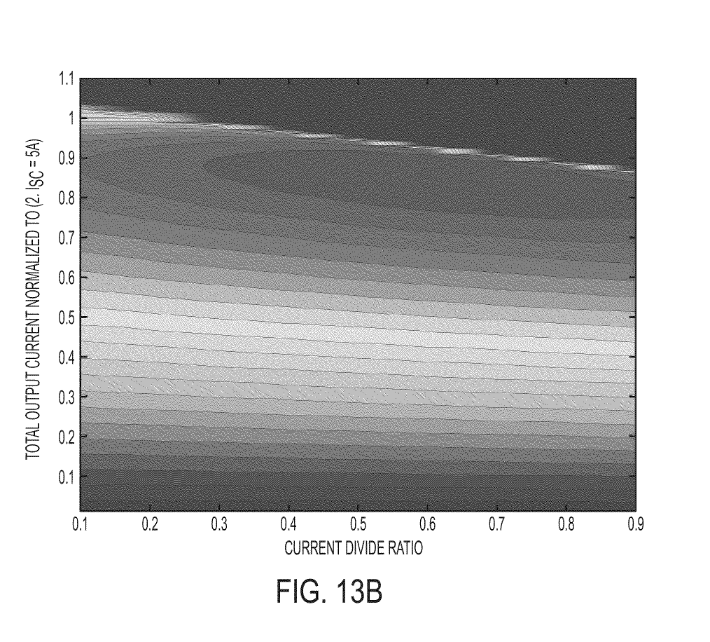

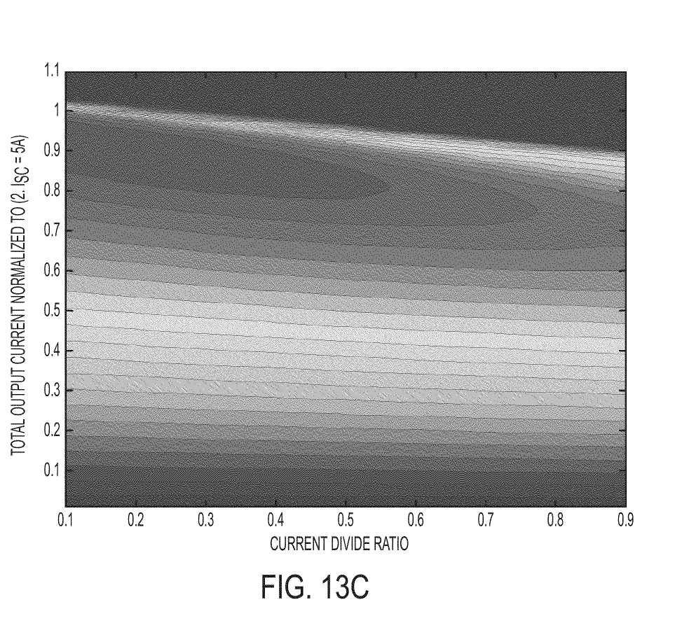

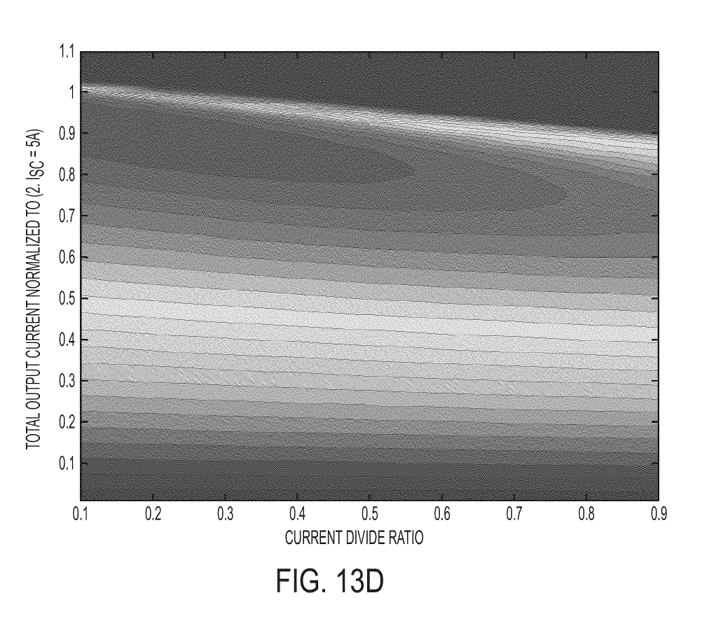

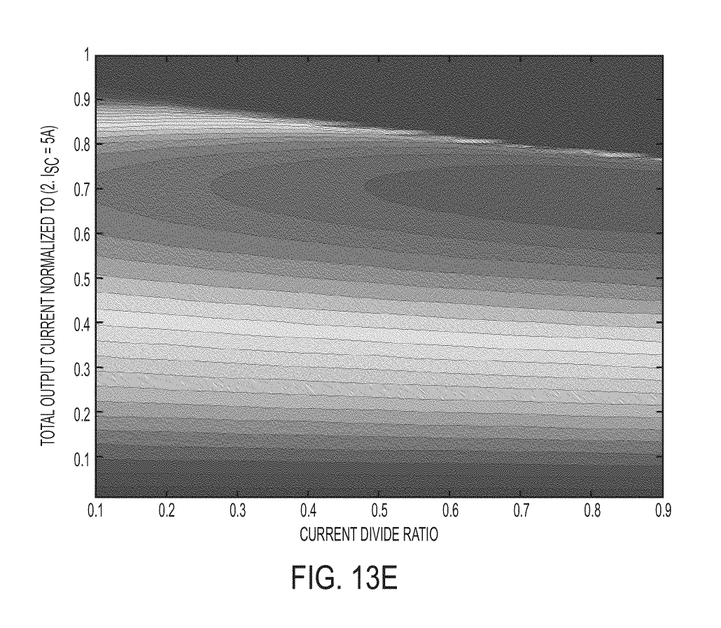

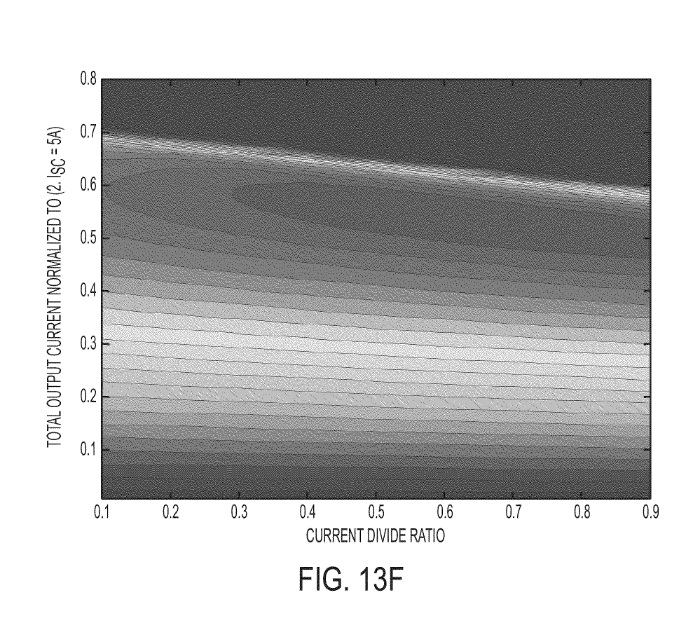

FIGS. 13A-F illustrates the simulated output power contours over the space spanned by the total output current Iₒᵤₜ and the current divide ratio D under various shading conditions. In these SPICE simulations, a 5-4 dDCR string is configured with load-connected cells numbered with odd indices and ladder-connected cells numbered with even indices, ascending from top to bottom as shown in FIG. 10.

The output power contour when the system is operating in uniform irradiance condition is shown in FIG. 13A, and a current divide ratio of D=0.5 is indeed where the peak power extraction occurs. Cases where the system experiences a symmetric center spot shading, an asymmetric termination spot shading, as well as a combination of these spots are illustrated in FIGS. 13B, 13C, and 13D respectively. Results for horizontal linear shading and randomly generated shading conditions are shown in FIGS. 13E and 13F. In all simulated cases, the output power contour is convex with only a single maximum power point over the entire space.

Since the output power contour is observed to be generally convex over a wide range of shading conditions, there is little to no risk of the optimization being stuck in a local maximum power point. Hence, the MPPT algorithm complexity for this multivariable optimization problem at the string level can be reduced, and well-known MPPT methods such as gradient descent or conjugate gradient methods can be adopted.

In conventional DPP topologies, where a single functional block capable of simultaneously achieving DPP and MPPT is employed and distributed at the desired level of optimization granularity, local MPPT controls the duty ratio of individual converters such that each PV elements operates at its local maximum power point. Although any of the existing and established MPPT algorithms can be adopted, having local control requires additional measurement and sensing hardware for each PV element.

In contrast, power balancing and optimization is inherent in the DCR switching topology such that charge redistribution occurs naturally. In this case, switch synchronization hardware may be used among adjacent converters. There is no need for full-fledged MPPT converters nor localized control to optimize the power for each PV element.

It was shown above that in order to achieve low overall insertion loss, a switching frequency in the range of hundreds of kilohertz was used given the available diffusion capacitance to maximum power current ratio. This constraint arises from the fact that the original DCR configuration processes the generated power from roughly half of the photovoltaic cells at all times. In the case of dDCR, the amount of processed power can be reduced significantly. Therefore, it is possible to decrease the switching frequency while maintaining a certain level of overall conversion efficiency.

For example, given a photovoltaic array installation and its expected amount of mismatch, a slower switching frequency can be determined and fixed at installation time to meet the desirable efficiency target of the project developer. Some embodiments may use adaptive frequency scaling during real-time operation

The dual current interface 28 can be implemented with two isolated string inverters as mentioned in the previous section. In this configuration, the two inverters can perform MPPT individually as the optimization space is shown to be generally convex. Moreover, redundancy and fault tolerance can be gained as added benefits. If one of the inverters fails, it does not necessarily result in total system failure and shutdown. The remaining inverter can continue to operate the system as a single-output DCR system with increased insertion loss, given that appropriate power rating headroom is factored into the system design.

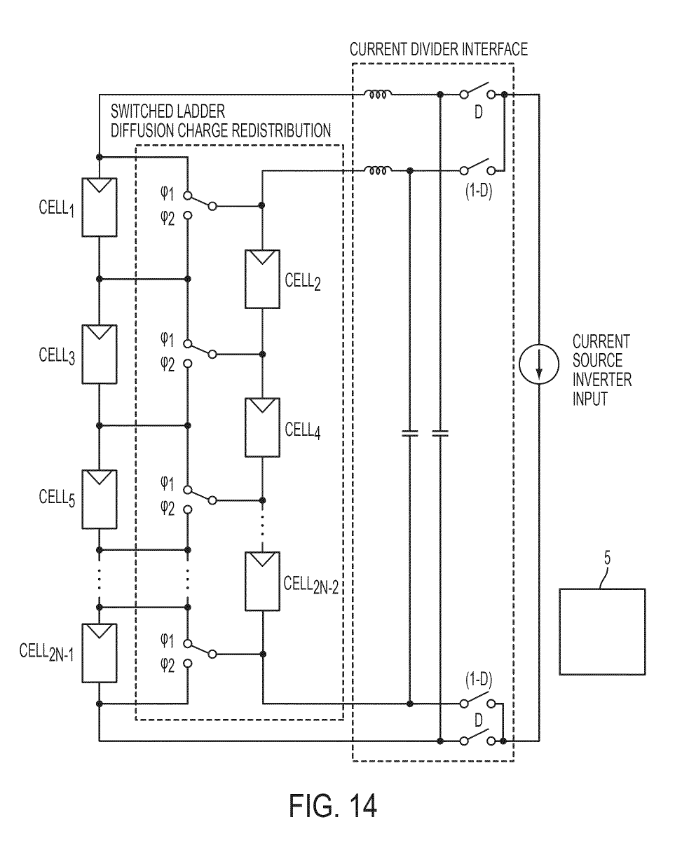

In systems where centralized inverters are used, a current divider interface preceding the inverter can be used. An example implementation of a current divider interface is shown in FIG. 14. In order for this topology to be adopted in practice, the conversion loss from current dividing is desired to be lower than the insertion loss the single-output DCR topology would otherwise incur. In this illustration, two inductors are inserted to enable adiabatic charging and discharging of the capacitive energy buffers. In other words, the capacitors are charged by near-constant current sources from the inductors and discharged by a constant current from the inverter. Hence, the capacitive charging and discharging losses can be drastically lowered, and the current divider can be extremely energy efficient.

The differential power processing architecture can also be extended to other existing maximum power point tracking topologies to enable differential power processing. For example, in PV installations with cascaded dc-dc converters, string connections may be added to the output of the PV modules in addition to the string connections at the output of the dc-dc converters. Together with the dual current source inverter interface, this enables both direct power extraction from the PV string and processed power extraction from the output of the cascaded dc-dc converters, and thereby achieves differential power processing with minimal extra hardware.

### ADDITIONAL ASPECTS

Various aspects of the apparatus and techniques described herein may be used alone, in combination, or in a variety of arrangements not specifically discussed in the embodiments described in the foregoing description and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items. For example, an apparatus, structure, device, layer, or region recited as “including,” “comprising,” or “having,” “containing,” “involving,” a particular material is meant to encompass at least the material listed and any other elements or materials that may be present.

What is claimed is:

1. A method, comprising:
re-distributing charge among a plurality of photovoltaic elements in a string using a photovoltaic element as switched charge storage to transfer charge between respective photovoltaic elements of the plurality of photovoltaic elements.

2. The method of claim 1, wherein each photovoltaic element of the plurality of photovoltaic elements comprises a single photovoltaic cell or a plurality of photovoltaic cells.

3. The method of claim 1, wherein the photovoltaic element used as the switched charge storage comprises a single photovoltaic cell or a plurality of photovoltaic cells.

4. The method of claim 1, wherein re-distributing the charge comprises equalizing voltages of the plurality of photovoltaic elements.

5. The method of claim 1, wherein re-distributing the charge comprises:
(A) connecting a first photovoltaic element of the plurality of photovoltaic elements in parallel with the photovoltaic element used as the switched charge storage.

6. The method of claim 5, wherein re-distributing the charge further comprises:
(B) connecting a second photovoltaic element of the plurality of photovoltaic elements in parallel with the photovoltaic element used as the switched charge storage.

7. The method of claim 6, wherein the method further comprises repeating (A) and (B) at a frequency high enough to equalize voltages of the plurality of photovoltaic elements.

8. The method of claim 6, wherein (A) and (B) are performed at least in part by a switch network.

9. The method of claim 6, wherein re-distributing the charge further comprises:
(C) concurrently with (A), connecting the second photovoltaic element of the plurality of photovoltaic elements in parallel with a second photovoltaic element used as switched charge storage.

10. A circuit comprising:
a switch network configured to re-distribute charge among a plurality of photovoltaic elements by switching a photovoltaic element in parallel with respective photovoltaic elements of the plurality of photovoltaic elements at different times.

11. The circuit of claim 10, wherein each photovoltaic element of the plurality of photovoltaic elements comprises a single photovoltaic cell or a plurality of photovoltaic cells.

12. A method, comprising:
switching connections between photovoltaic cells in a plurality of phases, the plurality of phases including:
a first phase comprising connecting a first group of one or more photovoltaic cells in parallel with a second group of one or more photovoltaic cells; and
a second phase comprising connecting the first group of one or more photovoltaic cells in parallel with a third group of one or more photovoltaic cells.

13. The method of claim 12, wherein the second group of one or more photovoltaic cells is in series with the third group of one or more photovoltaic cells.

14. The method of claim 12, wherein the switching is performed at a switching frequency of at least 1 kHz.

15. The method of claim 12, wherein the switching balances power produced by the second group of one or more photovoltaic cells with power produced by the third group of one or more photovoltaic cells.

16. A photovoltaic energy conversion apparatus, comprising:
a string of photovoltaic elements comprising a first photovoltaic element and a third photovoltaic element;
a second photovoltaic element; and
a switch network comprising one or more switches, the switch network being configured to switch the one or more switches in a plurality of phases, the plurality of phases including:
a first phase comprising connecting the second photovoltaic element in parallel with the first photovoltaic element; and
a second phase comprising connecting the second photovoltaic element in parallel with the third photovoltaic element.

17. The photovoltaic energy conversion apparatus of claim 16, wherein the first, second and third photovoltaic elements are arranged in a ladder configuration.

18. The photovoltaic energy conversion apparatus of claim 16, wherein the string of photovoltaic elements further comprises a fifth photovoltaic element, and wherein the photovoltaic energy conversion apparatus further comprises a second string of photovoltaic elements comprising the second photovoltaic element and a fourth photovoltaic element, wherein the first phase further comprises connecting the fourth photovoltaic element in parallel with the third photovoltaic element and the second phase further comprises connecting the fourth photovoltaic element in parallel with the fifth photovoltaic element.

19. The photovoltaic energy conversion apparatus of claim 16, wherein the second photovoltaic element is a flying photovoltaic element.

20. The photovoltaic energy conversion apparatus of claim 19, wherein the string further comprises a fourth photovoltaic element, and wherein the plurality of phases further includes a third phase comprising connecting the second photovoltaic element in parallel with the fourth photovoltaic element.

21. The photovoltaic energy conversion apparatus of claim 16, further comprising a circuit configured to draw a selected current from the string of photovoltaic elements.

22. The photovoltaic energy conversion apparatus of claim 21, wherein the photovoltaic energy conversion apparatus further comprises second string of photovoltaic elements comprising the second photovoltaic element.

23. The photovoltaic energy conversion apparatus of claim 22, wherein the circuit is configured to draw a second selected current from the second string.

24. A photovoltaic energy conversion system comprising a plurality of strings of photovoltaic elements, the photovoltaic energy conversion system comprising:
a controller that selects, based on an output power of the photovoltaic system, a total current to be drawn from the photovoltaic system and individual string currents to be drawn from individual strings of the plurality of strings of photovoltaic elements; and
at least one current source controlled by the controller to draw the total current from the photovoltaic system and the individual string currents from the individual strings.

25. The photovoltaic energy conversion system of claim 24, wherein the controller selects the total current and the individual string currents to optimize the output power of the photovoltaic energy conversion system.

26. The photovoltaic energy conversion system of claim 24, further comprising:
a switch network configured to re-distribute charge among a plurality of photovoltaic elements in the plurality of strings by switching a photovoltaic element of a first string in parallel with respective photovoltaic elements of a second string at different times.

27. A photovoltaic energy conversion method for a photovoltaic energy conversion system comprising a plurality of strings of photovoltaic elements, the photovoltaic energy conversion method comprising:
selecting, based on an output power of the photovoltaic system, a total current to be drawn from the photovoltaic system and individual string currents to be drawn from individual strings of the plurality of strings of photovoltaic elements; and
drawing the total current from the photovoltaic system and the individual string currents from the individual strings.

28. The photovoltaic energy conversion method of claim 27, wherein the total current and the individual string currents are selected to optimize the output power of the photovoltaic energy conversion system.
